(19) United States
(12) Patent Application Publication
(10) Pub. No.: US 2025/0180080 A1
(43) Pub. Date: Jun. 5, 2025

(54) Drive Device for a Drive Unit of an Electric Bike, Drive Unit and Electric Bike

(71) Applicant: Robert Bosch GmbH, Stuttgart (DE)

(72) Inventors: Heiko Roehm, Stuttgart (DE); Julian Binder, Wannweil (DE); Dietmar Saur, Moessingen (DE); Christoph Zimmermann, Nehren (DE); Lukas Mueller, Stuttgart (DE); Wolfgang Hau, Metzingen (DE); Sigmund Braun, Kusterdingen (DE); Joachim Klima, Kusterdingen (DE); Stefan Holst, Reutlingen (DE); Alexander Nau, Eningen Unter Achalm (DE)

(21) Appl. No.: 18/844,949

(22) PCT Filed: Mar. 1, 2023
(86) PCT No.: PCT/EP2023/055143

§ 371 Date: Sep. 7, 2024

(30) Foreign Application Priority Data
Mar. 18, 2022 (DE) 10 2022 202 694.2
Feb. 24, 2023 (DE) 10 2023 201 702.4

(51) Int. Cl. F16D 41/26; B62M 6/55

(52) U.S. Cl. CPC F16D 41/26; B62M 6/55

(57) ABSTRACT

A drive device for a drive unit of an electric bicycle has a bidirectional freewheeling assembly. The freewheeling assembly includes at least one clamping element unit.

### PRIOR ART

A drive device for a drive unit of an electric bicycle, having a bidirectional freewheeling assembly, has already been proposed.

### DISCLOSURE OF THE INVENTION

The invention proceeds from a drive device for a drive unit of an electric bicycle, having a bidirectional freewheeling assembly.

It is proposed that the freewheeling assembly comprises at least one clamping element unit. The freewheeling assembly is preferably configured as a freewheeling assembly based on a force-fit. The clamping element unit is preferably configured as a clamping member unit, as a clamping ball unit, or as a clamping roller unit. In particular, the freewheeling assembly is configured so as to be different from a ratchet freewheeling assembly. The drive unit preferably comprises an electric motor. The drive unit comprises in particular a gearbox for transmitting a driving force of the drive unit to an output sprocket of the drive unit. The output sprocket is configured, for example, as a chain ring or the like. The output sprocket is preferably connected to a gearbox output of the gearbox. The clamping element unit is preferably disposed on the gearbox output of the drive unit. Alternatively, it is also conceivable that the clamping element unit is disposed at another position within the gearbox. Alternatively, the drive device can also be used on a vehicle other than an electric bicycle. It is conceivable for the vehicle to comprise an internal combustion engine, an electric motor, or the like.

The drive device preferably comprises at least one force transmission element for transmitting a driving force of the drive unit. The clamping element unit is preferably disposed on the force transmission element. The force transmission element can be configured, for example, as a spur gear, as a planet gear, as a ring gear, as a sun gear or as any other force transmission element considered expedient by a person skilled in the art. The force transmission element preferably forms the gearbox output of the drive unit. Alternatively however, it is also conceivable for the force transmission element to be disposed within the gearbox and to be provided in particular for transmitting forces to a layshaft of the gearbox. The drive device preferably comprises at least one shaft. The shaft is preferably configured as an output shaft. Alternatively however, it is also conceivable for the shaft to be configured as a layshaft, which is in particular disposed within the gearbox, or the like. The output sprocket is preferably co-rotationally connected to the shaft configured as the output shaft. It is conceivable for the output sprocket to be configured so as to be integral to the output shaft. “Integral” can be understood to mean at least connected in a materially integral manner, for example by a welding process, an adhesive-bonding process, an overmoulding process, and/or any other process considered expedient by the person skilled in the art, and/or be understood to mean advantageously moulded in one piece, such as, for example, as a result of being produced from one casting and/or as a result of being produced in a single-or multi-component injection moulding method, and advantageously from a single blank.

The drive unit preferably comprises at least one pedal crankshaft. The pedal crankshaft is preferably able to be driven by a user by way of pedals. The drive device has in particular a forward rotation direction which corresponds in particular to a forward movement of the electric bicycle. The output sprocket is preferably connected to the pedal crankshaft in such a manner that the output sprocket is able to be driven by rotating the pedal crankshaft, in particular at least in one rotation direction, preferably in the direction of the forward rotation direction of the drive device. It is conceivable for the shaft to be connected so as to be rotatably mounted to the pedal crankshaft. Additionally, it is conceivable for the drive unit to have a further freewheeling assembly which is disposed between the shaft and the pedal crankshaft. The further freewheeling assembly is preferably provided to prevent any conjoint rotation of the pedal crankshaft in the event of a rotating shaft. Alternatively, it is conceivable for the shaft to be co-rotationally connected to the pedal crankshaft. Alternatively, it is in particular conceivable for the shaft to be configured so as to be integral to the pedal crankshaft. Furthermore alternatively, it is conceivable for the shaft to correspond to the pedal crankshaft. The shaft and the force transmission element are preferably disposed so as to be coaxial with a rotation axis of the freewheeling assembly. In particular, the shaft, the pedal crankshaft and/or the force transmission element are/is mounted so as to be rotatable about the rotation axis.

The clamping element unit is preferably specified to interrupt a transmission of a motor torque, which in terms of the forward direction of the electric bicycle is directed forwards, to the shaft, in particular the output sprocket, when a rotating speed of the shaft is higher than a rotating speed of the force transmission element driven by the motor torque. It is also conceivable for the clamping element unit to be specified to interrupt a transmission of a motor torque, which in terms of the forward direction of the electric bicycle is directed rearwards, to the shaft, in particular the output sprocket, when the rotating speed of the shaft, in particular of the output sprocket, is higher than the rotating speed of the force transmission element driven by the motor torque. The clamping element unit is preferably specified to interrupt a transmission of a torque of the shaft, in particular of the output sprocket, from the shaft, in particular the output sprocket, to the force transmission element, preferably the gearbox and/or the electric motor, when the shaft, in particular the output sprocket, in terms of the forward rotation direction, in particular the forward direction of the electric bicycle, rotates backwards. The clamping element unit is preferably specified to interrupt the transmission of the torque of the shaft, in particular of the output sprocket, from the shaft, in particular from the output sprocket, to the force transmission element, preferably to the gearbox and/or the electric motor, independently of the rotating speed of the force transmission element and independently of the rotating speed of the shaft, in particular of the output sprocket.

The clamping element unit preferably comprises at least one clamping element. The clamping element, in a clamped state of the clamping element, in particular between the force transmission element and the shaft, is preferably provided to transmit torque between the force transmission element and the shaft. The at least one clamping element, in a state of the clamping element decoupled from the force transmission element and/or the shaft, in particular in a freely rotating state of the clamping element, and/or a state of the clamping element spaced apart from the force transmission element and/or the shaft, is preferably provided to interrupt a transmission of torque between the force transmission element and the shaft. The clamping element is configured, for example, as a rolling member, as a, for example non-round, clamping member, or the like. The clamping element is preferably configured so as to be different from a ratchet. It is also conceivable for the clamping element unit to comprise a multiplicity of clamping elements, in particular at least two, preferably at least three, clamping elements.

As a result of the design embodiment according to the invention of the drive device, a bidirectional freewheeling assembly for a drive unit of an electric bicycle which has a particularly rapid response can advantageously be provided. A bidirectional freewheeling assembly for a drive unit of an electric bicycle which is particularly silent can advantageously be implemented. A particularly gentle operation of a drive unit, in particular of a gearbox and/or of an electric motor, can advantageously be implemented as a result of the drive device. Any undesirable transmission of torque from the shaft to the force transmission element as a result of a movement of the shaft in an arbitrary rotation direction can advantageously be counteracted. A transmission of undesirable torques from an output side to the electric motor and/or at least part of the gearbox can advantageously be counteracted.

It is furthermore proposed that the clamping element unit is provided for decoupling vibrations of a wrapping means. The wrapping means is configured, for example, as a chain, as a belt, or the like. The wrapping means is preferably co-rotationally connected to the output shaft, in particular the output sprocket. The wrapping means is in particular provided to transmit a driving force from the shaft, preferably configured as an output shaft, in particular from the output sprocket, to a drive wheel of the electric bicycle. The drive wheel is preferably configured as a rear wheel of the electric bicycle. Alternatively however, it is also conceivable for the drive wheel to be configured as a front wheel of the electric bicycle. The clamping element unit is preferably provided to counteract a transmission of vibrations of the wrapping means to components of the drive unit which, proceeding from the wrapping means, are disposed behind the clamping element unit in the drivetrain. The clamping element unit is preferably provided to counteract a transmission of vibrations of the wrapping means to the gearbox and/or the electric motor. A particularly gentle operation can advantageously be guaranteed. As a result of the use of the clamping element unit, a particularly durable drive device, preferably drive unit, in particular a particularly durable electric motor and/or a particularly durable gearbox, can advantageously be provided. Gearbox rattling can advantageously be counteracted. The decoupling of vibrations of a wrapping means can advantageously be performed in a particularly silent manner.

It is furthermore proposed that the clamping element unit comprises at least one rolling member, in particular a roller. Alternatively, it is also conceivable for the rolling member to be configured as a ball, as a drum, as a needle, as a cone, or as any other rotating member considered expedient by a person skilled in the art. The rolling member is preferably configured so as to be rotationally symmetrical. The at least one rolling member, in a clamped state of the rolling member, is preferably provided to transmit torque between the force transmission element and the shaft. The at least one rolling member, in a freely rotating state of the rolling member, is preferably provided to interrupt a transmission of torque between the force transmission element and the shaft. The clamping element unit preferably comprises a multiplicity of rolling members, in particular at least two, preferably at least three rolling members. The clamping element unit comprises, for example, at least one sleeve which is in particular disposed on the force transmission element. The sleeve is preferably co-rotationally connected to the force transmission element. The sleeve is preferably configured so as to be integral to the force transmission element. It is also conceivable for the sleeve to be formed by the force transmission element. The at least one rolling member is in particular disposed between the force transmission element, in particular the sleeve, and the shaft. The rolling members are preferably uniformly disposed. A multiplicity of rolling members are preferably disposed uniformly along a circumferential direction of the shaft, which preferably runs in a plane perpendicular to the rotation axis. The drive device preferably comprises at least one bearing unit which is at least partially disposed between the force transmission element, in particular the sleeve, and the shaft. The bearing unit is in particular at least provided to mount the force transmission element and the shaft so as to be mutually rotatable and/or at a fixed radial spacing relative to one another. The bearing unit preferably comprises at least one bearing element, for example a plain bearing ring or the like. The at least one bearing element is preferably disposed between the force transmission element, in particular the sleeve, and the shaft. The clamping element unit has in particular at least one clamping face. The force transmission element, in particular the sleeve, preferably comprises the at least one clamping face. The clamping face is in particular provided to interact with the at least one rolling member so as to transmit torque between the force transmission element and the shaft. The clamping element unit preferably has at least one further clamping face. The further clamping face is preferably provided to interact with the at least one rolling member so as to transmit torque between the force transmission element and the shaft. The shaft preferably has a circular- cylindrical shell face. The further clamping face is preferably formed by the circular- cylindrical shell face of the shaft. The at least one rolling member is particularly preferably provided to be clamped by the clamping face and the further clamping face so as to transmit torque between the force transmission element and the shaft. The force transmission element, in particular the sleeve, preferably has an internal face. The internal face faces towards the shaft in particular. The internal face preferably comprises the at least one clamping face. The force transmission element, in particular the sleeve, preferably has at least one recess for disposing the at least one rolling member. The at least one rolling member is able to be at least partially disposed in the at least one recess. The clamping face is preferably disposed in the at least one recess of the sleeve, in particular of the force transmission element. A number of recesses preferably corresponds to a number of rolling members of the clamping element unit. The at least one recess, in particular at least when viewed in a circumferential direction of the force transmission element, which preferably lies in a plane which runs perpendicularly to the rotation axis, is preferably configured so as to be asymmetrical. The at least one recess is preferably configured in such a manner that the at least one rolling member is able to be disposed in the recess in a clamping position on the clamping face and in a freely rotating position. A bidirectional freewheeling assembly which has a particularly rapid response can advantageously be implemented. A bidirectional freewheeling assembly for a drive unit of an electric bicycle which is particularly silent can advantageously be implemented.

It is furthermore proposed that the clamping element unit comprises a clamping element holding member. The clamping element holding member preferably has at least one receptacle region for the at least one clamping element, in particular the at least one rolling member. The clamping element holding member is preferably configured so as to be annular. The clamping element holding member is in particular configured as a cage ring. A number of receptacle regions preferably corresponds to the number of clamping elements, in particular rolling members, of the clamping element unit. The receptacle regions are preferably disposed so as to be separate from one another. The at least one receptacle region preferably delimits a movement of the at least one clamping element, in particular of the at least one rolling member, preferably about the rotation axis, preferably in the circumferential direction, relative to the clamping element holding member. The clamping element holding member is preferably disposed between the shaft and the force transmission element, in particular the sleeve. The clamping element holding member is preferably disposed so as to be movable relative to the force transmission element, in particular the sleeve, and/or the shaft. The clamping element holding member is in particular specified to guide the at least one rolling member. It is conceivable for the clamping element, in particular the rolling member, to be disposed without a spring on the clamping element holding member. The at least one receptacle region for the at least one clamping element, in particular the at least one rolling member, is preferably free of spring elements. In particular, a region between the at least one clamping element, preferably the at least one rolling member, and the clamping element holding member, in particular at least in the receptacle region, is free of spring elements. The at least one clamping element, in particular the at least one rolling member, is preferably free of a mounting by means of spring elements on the clamping element holding member. Alternatively however, it is also conceivable that the at least one clamping element, in particular the at least one rolling member, is disposed so as to be spring-mounted on the clamping element holding member, preferably in the at least one receptacle region. For example, a bearing spring for resilient mounting of the at least one clamping element is disposed between the at least one clamping element, in particular the at least one rolling member, and the clamping element holding member, preferably in the receptacle region. The bearing spring is configured, for example, as a flexible spring, as a torsion spring, as a rubber-elastic element, or the like. It is conceivable for the bearing spring to be fastened to the clamping element holding member. It is also conceivable for the bearing spring to be configured so as to be integral to the clamping element holding member. A particularly reliable function of the clamping element unit can advantageously be implemented. A bidirectional freewheeling assembly which is particularly reliable can advantageously be made available.

It is furthermore proposed that the clamping element unit comprises a mechanical control unit. The control unit is preferably provided for changing between a freewheeling state and a torque-transmitting state of the freewheeling assembly. The freewheeling state is preferably a state of the freewheeling assembly in which a transmission of torque between the force transmission element and the shaft is interrupted. The torque-transmitting state is preferably a state of the freewheeling assembly in which a transmission of torque between the force transmission element and the shaft takes place. A changeover between the freewheeling state and the torque-transmitting state preferably takes place automatically by means of the control unit, in particular free of any intervention by a user and/or free of any electronic control. The control unit is preferably free of electrical components. Alternatively however, it is also conceivable for the clamping element unit to comprise an electronic control unit. An electrical energy supply for controlling the clamping element unit can advantageously be dispensed with.

Moreover, it is proposed that the control unit has a friction unit which is provided for generating an actuating force. The friction unit is provided in particular to move the clamping element holding member relative to the force transmission element and/or the shaft, preferably to rotate said clamping element holding member about the rotation axis. The friction unit is particularly preferably at least provided to release a torque-transmitting state of the freewheeling assembly as a function of a relative movement of the force transmission element to the shaft. The friction unit, as a function of a relative movement of the force transmission element to the shaft, is preferably at least provided to switch the freewheeling assembly by the actuating force from the torque-transmitting state of the freewheeling assembly to the freewheeling state of the freewheeling assembly. The friction unit is in particular provided to position the at least one rolling member relative to the force transmission element, in particular the sleeve, and/or the shaft, preferably so as to switch the freewheeling assembly, preferably at least from the torque-transmitting state to the freewheeling state. The friction unit is provided to generate a frictional force between the clamping element holding member and a friction member which is configured separately from the clamping element holding member. Frictional contact between the clamping element holding member and the friction member is preferably formed by the friction unit. The friction unit has in particular at least one friction element. The friction unit preferably comprises a multiplicity of friction elements, preferably at least two, particularly preferably at least three friction elements. The at least one friction element is provided for forming the frictional contact between the clamping element holding member and the friction member. The at least one friction element preferably has at least one friction face for forming the frictional contact between the clamping element holding member and the friction member. The at least one friction element is preferably fastened to the clamping element holding member. It is conceivable for the at least one friction element to be configured so as to be integral to the clamping element holding member or to be separate from the clamping element holding member. Alternatively, it is also conceivable for the at least one friction element to be fastened to the friction member, in particular to be configured so as to be integral to the friction member. The friction element is preferably configured as a spring- elastic element, as a rubber-elastic element, or as any other friction element considered expedient by a person skilled in the art. The friction member is preferably formed by a stationary component of the freewheeling assembly. In at least one exemplary embodiment in particular, the friction member is co-rotationally connected to a housing component of a housing of the drive unit. The friction member is configured, for example, as a friction ring or the like. Alternatively, it is also conceivable for the friction member to be formed by a stationary component of the electric bicycle, in particular of the drive unit. Alternatively, the friction member is formed, for example, by a frame element of the frame of the electric bicycle, by the housing component of the housing of the drive unit, or the like. The actuating force is preferably a frictional force. In particular, the friction unit, in at least one operating state of the freewheeling assembly, is provided to generate the actuating force by static friction and/or dynamic friction between the clamping element holding member and the friction member. The actuating force, in particular the frictional force, at least in the operating state of the freewheeling assembly, preferably acts counter to a torque prevailing on the clamping element holding member. The actuating force, preferably the frictional force, is preferably provided to decelerate a rotation of the clamping element holding member about the rotation axis relative to the shaft, in particular at least in the freewheeling state. The clamping element unit, by means of the at least one clamping face, is preferably specified to clamp the at least rolling member in the at least one recess when the rotating speed of the force transmission element in the forward rotation direction is more than or equal to the rotating speed of the shaft. The friction unit, during a rotation of the force transmission element in the forward rotation direction, wherein a rotating speed of the force transmission element is more than a rotating speed of the shaft, by means of the actuating force, in particular the frictional force, is preferably provided to brake the clamping element holding member relative to the force transmission element, so as to preferably bring into contact the at least one rolling member with the at least one clamping face in the at least one recess of the force transmission element, in particular the sleeve, and to clamp said rolling member. In particular, the clamping element unit, by way of the actuating force, preferably the frictional force, during a rotation of the shaft which in terms of the forward rotation direction is directed backwards, is provided to generate a force on the at least one rolling member, so as to preferably release the at least one rolling member from the at least one clamping face so that the freewheeling assembly is preferably switched to the freewheeling state. Clamping of the at least one rolling member by way of the force transmission element, in particular the sleeve, and the shaft can preferably be generated by the actuating force, in particular the frictional force, when the rotating speed of the force transmission element is higher than the rotating speed of the shaft, preferably at least during a rotation of the force transmission element which in terms of the forward rotation direction is directed forwards. As a result of the clamping of the at least one rolling member by way of the force transmission element, in particular the sleeve, and the shaft, a torque is preferably able to be transmitted between the force transmission element and the shaft. The at least one rolling member in the torque-transmitting state is preferably co- rotationally connected to the force transmission element, in particular the sleeve, and the shaft. The at least one rolling member is in the clamping position in particular when the freewheeling assembly is in the torque-transmitting state. The at least one rolling member in the freewheeling state is preferably disposed so as to freely rotate in the at least one recess. The at least one rolling member is preferably in a freely rotating position when the freewheeling assembly is in the freewheeling state. In particular, the at least one rolling member is disposed so as to freely rotate in the at least one recess when the shaft in terms of the forward rotation direction rotates backwards. The at least one rolling member is preferably disposed so as to freely rotate in the at least one recess when the shaft in terms of the forward rotation direction rotates forwards, and the rotating speed of the shaft is higher than the rotating speed of the force transmission element. The at least one rolling member is preferably disposed so as to freely rotate in the at least one recess when the force transmission element in terms of the forward rotation direction rotates backwards. The clamping element unit, by means of the clamping element holding member, is in particular provided to release the at least one rolling member from the clamping action when the rotating speed of the shaft is higher than the rotating speed of the force transmission element. A mechanical control unit for the clamping element unit can advantageously be implemented in a structurally simple manner. Particularly robust mechanical control for the clamping element unit can advantageously be made available.

It is furthermore proposed that the friction unit has at least one spring unit. The clamping element holding member is preferably connected to the friction member by way of the spring unit. The spring unit is preferably provided to generate a holding force between the clamping element holding member and the friction member. The spring unit is preferably provided to generate the actuating force, in particular the frictional force, of the friction unit. The spring unit has at least one spring element, for example. The at least one friction element is preferably formed by the at least one spring element. It is conceivable for the at least one spring element to be configured as a flexible spring, as a torsion spring, as a plate spring, as a volute spring, as an annular spring, or the like. Alternatively, it is also conceivable for the spring element to be configured as a rubber-elastic element. The at least one spring element is preferably disposed on the clamping element holding member. The at least one spring element is preferably disposed between the clamping element holding member and the friction member. In particular, the clamping element holding member is able to be connected to the friction member by way of the at least one spring element. A mechanical control unit for the clamping element unit can advantageously be implemented by way of a simple construction. Particularly robust mechanical control for the clamping element unit can advantageously be made available. Particularly effective frictional contact between the clamping element holding member and the friction member can advantageously be implemented.

It is furthermore proposed that the spring unit comprises at least one flexible spring. The at least one flexible spring is formed by the at least one spring element, for example. The spring unit is preferably configured so as to be free of coil springs. The at least one flexible spring is configured, for example, as a leaf spring, as a wire spring, in particular as a needle spring, as a leg spring, or the like. Particularly effective frictional contact between the clamping element holding member and the friction member can advantageously be implemented.

It is furthermore proposed that the spring unit comprises at least one leaf spring. The at least one leaf spring is preferably formed by the at least one spring element, in particular the at least one flexible spring. It is conceivable for the leaf spring to be configured as a spiral spring, as a cushioning spring, as an elliptic spring, as a parabolic spring, as a serpentine spring, or as any other leaf spring considered expedient by a person skilled in the art. The leaf spring preferably has at least one spring arm. The at least one friction face of the friction unit is in particular disposed on the at least one spring element, in particular on the leaf spring. The friction face of the friction element is preferably disposed on the at least one spring arm. It is conceivable for the leaf spring to be configured as a single-arm leaf spring or as a leaf spring having at least two arms. It is conceivable for the friction face to extend in the axial direction and/or in the radial direction. It is conceivable for the friction face to be at least partially curved and/or to run so as to be at least partially rectilinear. At least one plane of main extent of the at least axially extending friction face preferably runs so as to be at least substantially parallel to the axial direction. A “plane of main extent” of a module or of an element can be understood to be a plane which is parallel to a largest lateral face of a smallest possible imaginary cuboid which just completely encloses the module or the element and runs in particular through the centre of the cuboid. “Substantially parallel” can be understood here to be an alignment in a direction relative to a reference direction, in particular in a plane, wherein the direction in relation to the reference direction has a deviation of in particular less than 8°, advantageously less than 5°, and particularly advantageously less than 2°. At least the plane of main extent of the at least radially extending friction face preferably runs so as to be at least substantially parallel to the radial direction. It is conceivable for the friction face, which extends in particular in the axial direction, to be oriented radially inwards or radially outwards. It is also conceivable for the friction face, which extends in particular in the radial direction, to be oriented in the direction of the clamping element holding member, or so as to face away from the clamping element holding member, preferably at least when viewed in the axial direction. Particularly effective frictional contact between the clamping element holding member and the friction member can advantageously be implemented.

It is moreover proposed that the leaf spring is configured as a leaf spring having at least two arms. The leaf spring having at least two arms preferably has at least two friction faces of the friction unit so as to form the friction contact between the clamping element holding member and the friction member. The spring having at least two arms has in particular at least two spring arms. One of the friction faces is in each case preferably disposed on the spring arms. Particularly effective frictional contact between the clamping element holding member and the friction member can advantageously be implemented by the two-arm leaf spring. A particularly large friction face can advantageously be implemented.

It is furthermore proposed that the spring unit has at least one, in particular the spring element already mentioned above, which at least to a major extent surrounds a, in particular the rotation axis, already mentioned above, of the freewheeling assembly. An element surrounding an axis at least to a major extent is to be understood to mean in particular that the element surrounds the axis to the extent of at least 55%, preferably to the extent of at least 65%, preferably to the extent of at least 75%, particularly preferably to the extent of at least 85%, and most particularly preferably at least to the extent of at least 95%, in a circumferential direction, which lies in a plane running perpendicularly to the axis, of the axis. The spring element which surrounds the rotation axis of the freewheeling assembly at least to a major extent is preferably configured so as to be annular. It is conceivable for the at least one spring element which surrounds the rotation axis of the freewheeling assembly at least to a major extent has at least in part a curved profile along the main extent thereof and/or along the main extent thereof has portions that run in a rectilinear manner and are angled at least in part in relation to one another. A spring unit which in terms of construction can be implemented in a particularly simple manner can advantageously be made available. In particular, many contact points between the at least one spring element and the clamping element holding member can advantageously be implemented. In particular, many contact points between the at least one spring element and the friction member can advantageously be implemented. Particularly effective and/or uniform frictional contact between the clamping element holding member and the friction member can advantageously be implemented. A spring unit having a particularly small number of components can advantageously be implemented. Particularly simple and rapid assembling of the spring unit on the clamping element holding member can advantageously be implemented.

It is furthermore proposed that the spring unit has at least one spring element, in particular the spring element already mentioned above, having at least one assembly ramp. The assembly ramp is in particular provided to guide the at least one spring element when assembling the spring element on the friction member. The assembly ramp is preferably provided to contact the friction member when the spring element is assembled on the friction member, and in particular to guide the spring element in a movement in the direction of an envisaged assembly position. The at least one assembly ramp is preferably disposed on the at least one spring arm of the spring element configured as a leaf spring. The assembly ramp is in particular formed by a face which runs so as to be angled in relation to the rotation axis, preferably in a manner other than perpendicularly. Particularly simple and/or rapid assembling of the clamping element unit on the friction member can advantageously be implemented. Particularly rapid and cost-effective production of a bidirectional freewheeling assembly having a clamping element unit can advantageously be achieved.

It is furthermore proposed that the spring unit has at least one spring element, in particular the spring element already mentioned above, which is configured separately from the clamping element holding member. It is conceivable for the spring element, configured separately from the clamping element holding member, to be fastened to the clamping element holding member or to be fastened to the friction member, in particular to be configured so as to be integral to the friction member. It is also conceivable for the spring element, configured separately from the clamping element holding member, to be at least partially formed from a material which corresponds to a material of the clamping element holding member, or is different from the material of the clamping element holding member. For example, the clamping element holding member is formed from a plastics material. Alternatively however, it is also conceivable for the clamping element holding member to be formed from a metal or any other material considered expedient by a person skilled in the art. The at least one spring element is preferably formed from a metal. Alternatively however, it is also conceivable that the spring element is formed from a plastics material or any other material considered expedient by a person skilled in the art. Different materials can advantageously be used for the at least one spring element and the clamping element holding member. The materials for the clamping element holding member and the at least one spring element can advantageously be chosen so as to be particularly suitable. The materials for the clamping element unit can advantageously be chosen in a particularly flexible manner at least in terms of costs, stability, weight and/or durability.

It is furthermore proposed that the spring unit has at least one spring element, in particular the spring element already mentioned above, which is fastened to a member that is separate from the clamping element holding member. The member is preferably a stationary component of the freewheeling assembly or of the electric bicycle, in particular of the drive unit. For example, the member is formed by the housing component of the drive unit, the frame element, or the like. It is conceivable for the member to be formed by the friction member. It is conceivable for the at least one spring element to be configured so as to be integral to the member, or to be fastened on the member so as to be releasable, preferably in a non-destructive manner. A total mass of moving parts of the drive device can advantageously be kept low. Undesirable inertial forces can advantageously be kept low. A clamping element unit for the bidirectional freewheeling assembly, which has a particularly rapid response, can advantageously be made available.

It is furthermore proposed that the spring unit has at least one spring element, in particular the spring element already mentioned above, which is fastened to the clamping element holding member. For example, the spring element is configured so as to be integral to the clamping element holding member, is latched, clamped, screwed to the clamping element holding member, or the like. Particularly reliable positioning of the spring element can advantageously be achieved. Particularly reliable and precise functioning of the clamping element unit, preferably of the control unit, can advantageously be implemented.

It is moreover proposed that the spring unit has at least one spring element, in particular the spring element already mentioned above, which is configured so as to be integral to the clamping element holding member. A particularly robust clamping element unit can advantageously be made available. A particularly secure connection between the clamping element holding member and the spring elements can advantageously be achieved. A control unit for controlling the clamping element unit with particularly high reliability can advantageously be implemented.

It is furthermore proposed that the spring unit has at least one spring element, in particular the spring element already mentioned above, which is overmoulded by the clamping element holding member. The spring element is preferably at least partially overmoulded by the clamping element holding member. A particularly secure connection between the clamping element holding member and the spring elements can advantageously be achieved. A control unit for controlling the clamping element unit with particularly high reliability can advantageously be implemented. The at least one spring element is advantageously disposed in a particularly captive manner.

It is furthermore proposed that the friction unit comprises a friction face, in particular the friction face already mentioned above, which extends in the axial direction. The axial direction preferably runs parallel to the rotation axis. A particularly compact construction mode of the drive device at least in the radial direction can advantageously be achieved.

It is furthermore proposed that the friction face extending in the axial direction, when viewed in the axial direction, is disposed on a side that faces the clamping element holding member. In at least one exemplary embodiment, the at least one spring arm of the spring element is preferably disposed on that side that faces the clamping element holding member, in particular at least when viewed in the axial direction. A particularly compact clamping element unit for the bidirectional freewheeling assembly can advantageously be implemented.

It is moreover proposed that the friction face extending in the axial direction, when viewed in the axial direction, is disposed on a side that faces away from the clamping element holding member. In at least one exemplary embodiment, the at least one spring arm of the spring element is preferably disposed on that side that faces away from the clamping element holding member, in particular at least when viewed in the axial direction. Particularly simple assembling of the clamping element holding member on the friction member can advantageously be achieved.

It is furthermore proposed that, in particular in at least one exemplary embodiment, the friction face extending in the axial direction, when viewed in the radial direction, is oriented inwards. The at least one friction face in at least one exemplary embodiment is preferably disposed so as to face the shaft. The at least one friction face in at least one exemplary embodiment is in particular disposed so as to face the rotation axis. A particularly compact clamping element unit having a friction unit can advantageously be implemented. A freewheeling assembly with a particularly rapid response and a particularly compact construction mode can advantageously be made available.

It is furthermore proposed that the friction unit comprises at least two friction elements, in particular the friction elements already mentioned above, for generating an actuating force, wherein the friction elements are disposed uniformly in a circumferential direction of the clamping element holding member, said circumferential direction running in particular in a plane perpendicular to the rotation axis. The friction elements are preferably disposed uniformly in the circumferential direction on the clamping element holding member or the friction member. The friction elements are preferably formed by spring elements of the spring unit. Alternatively however, it is also conceivable for the friction elements to be disposed non-uniformly in the circumferential direction, preferably on the clamping element holding member or the friction member. A particularly uniform holding force and/or frictional force between the clamping element holding member and the friction member can advantageously be implemented. Particularly reliable and precise functioning of the clamping element unit for the bidirectional freewheeling assembly can advantageously be made available.

It is moreover proposed that the drive device comprises at least one force transmission element, in particular the force transmission element already mentioned above, for transmitting a driving force of the drive unit, said force transmission element having at least one lead through by way of which the clamping element holding member in the radial direction is at least partially guided towards the outside. It is conceivable for a number of lead throughs to correspond to a number of friction elements, in particular spring elements. However, it is also conceivable for the number of lead throughs to differ from a number of friction elements, in particular spring elements. The at least one friction element, preferably the at least one spring element, in particular in at least one exemplary embodiment, is at least partially disposed in the at least one lead through. The at least one lead through in particular in at least one exemplary embodiment is free of friction elements, in particular spring elements. A bidirectional freewheeling assembly which has a particularly rapid response can advantageously be embodied in a particularly compact manner. Weight can advantageously be saved as a result of the design embodiment of the force transmission element with lead throughs.

It is furthermore proposed that the drive device comprises at least one force transmission element, in particular the force transmission element already mentioned above, for transmitting a driving force of the drive unit, wherein the force transmission element is configured as a spur gear. The spur gear preferably has an external toothing. It is conceivable for the external toothing to be configured as a spur toothing or as a helical toothing. Particularly simple assembling of the clamping element unit on the force transmission element can advantageously be achieved.

It is furthermore proposed that a value of a maximum diameter of the at least one rolling member is between 6% and 20% of a value of a maximum internal diameter of the force transmission element, in particular of the sleeve. A value of the maximum diameter of the at least one rolling member is preferably at most 15%, particularly preferably at most 10%, of a value of the maximum internal diameter of the force transmission element, in particular of the sleeve. Alternatively however, it is also conceivable for a value of the maximum diameter of the at least one rolling member to be outside a range of 6% to 20% of a value of the maximum internal diameter of the force transmission element, in particular of the sleeve. The internal diameter is in particular measured in the radial direction. The maximum diameter of the rolling member is preferably measured in the radial direction. A clamping element unit having a particularly high packing density in terms of the rolling members can advantageously be achieved. A particularly reliable and precise bidirectional freewheeling assembly can advantageously be implemented as a result of the high packing density of the rolling members in the clamping element holding member.

It is furthermore proposed that the drive device comprises at least one shaft, in particular the shaft already mentioned above, wherein a value of a maximum diameter, in particular of the diameter already mentioned above, of the at least one rolling member is between 8% and 25% of a value of a maximum diameter of the shaft. A value of the maximum diameter of the at least one rolling member is preferably at most 15%, particularly preferably at most 12%, of a value of the maximum diameter of the shaft. Alternatively however, it is also conceivable for a value of the maximum diameter of the at least one rolling member to be outside a range of 8% to 25% of a value of the maximum diameter of the shaft. The maximum diameter of the shaft is in particular measured in the radial direction. A value of the maximum diameter of the shaft is in particular at most 38 mm; a value of the maximum diameter of the shaft is particularly preferably 32 mm. A clamping element unit having a particularly high packing density in terms of the rolling members can advantageously be achieved. A particularly reliable and precise bidirectional freewheeling assembly can advantageously be implemented as a result of the high packing density of the rolling members in the clamping element holding member.

It is moreover proposed that a value of a maximum internal diameter, in particular of the internal diameter already mentioned above, of the force transmission element, in particular of the sleeve, is at most 46 mm. A value of the maximum internal diameter of the force transmission element, in particular of the sleeve, is preferably between 40 mm and 41 mm. Alternatively however, it is also conceivable for a value of the maximum internal diameter of the force transmission element to be more than 46 mm. A particularly compact drive device having a bidirectional freewheeling assembly can advantageously be made available.

It is furthermore proposed that a value of a maximum diameter, in particular of the diameter already mentioned above, of the rolling member is at most 5 mm. A value of the maximum diameter of the rolling member is preferably substantially 3.5 mm. A variable being at least substantially a stated value is to be understood to mean in particular that an actual value of the variable deviates from the stated value by at most 10%, particularly preferably at most 5%. Alternatively however, it is also conceivable for a value of the maximum diameter of the rolling member to be more than 5 mm. A particularly compact drive device having a bidirectional freewheeling assembly can advantageously be made available. A clamping element unit having a particularly high packing density in terms of the rolling members can advantageously be achieved. A particularly reliable and precise bidirectional freewheeling assembly can advantageously be implemented as a result of the high packing density of the rolling members in the clamping element holding member.

It is furthermore proposed that a maximum motion angle, in particular a translatory angle, of the rolling member relative to the clamping element holding member about a rotation axis, in particular the rotation axis already mentioned above, of the freewheeling assembly is at most 1.5°. The maximum motion angle, in particular translatory angle, of the at least one rolling member relative to the clamping element holding member is preferably between 0° and 1°. In particular in an exemplary embodiment in which the rolling member is disposed so as to be spring-mounted on the clamping element holding member. The maximum motion angle, in particular translatory angle, of the at least one rolling member relative to the clamping element holding member is particularly preferably substantially 0.5°. Alternatively however, it is also conceivable for the maximum motion angle, in particular translatory angle, of the at least one rolling member relative to the clamping element holding member about the rotation axis to be more than 1.5°. A precise bidirectional freewheeling assembly which has a particularly rapid response can advantageously be made available.

It is furthermore proposed that a maximum angle between a clamping position, in particular the clamping position already mentioned above, of the rolling member and a maximum freely rotating position of the rolling member about a rotation axis, in particular the rotation axis already mentioned above, of the freewheeling assembly is at most 5°. The maximum angle between the clamping position of the rolling member and the maximum freely rotating position of the rolling member about the rotation axis of the freewheeling assembly is preferably at most 2.5°. The maximum angle between the clamping position of the rolling member and the maximum freely rotating position of the rolling member about the rotation axis of the freewheeling assembly is preferably between 0.3° and 2.5°, particularly preferably between 0.4° and 2°. The maximum angle between the clamping position of the at least one rolling member and the maximum freely rotating position of the at least one rolling member about the rotation axis is very particularly preferably at least substantially 0.8°. The maximum freely rotating position and/or the clamping position of the rolling member are/is located in particular in the at least one recess for the at least one rolling member. The maximum freely rotating position and the clamping position are preferably located at mutually opposite end regions of the recess. The at least one further clamping face is preferably disposed on a rear side of the recess in terms of the forward rotation direction. The freely rotating position is preferably disposed on a front side of the recess in terms of the forward rotation direction. In particular, the recess, in the end region in which the freely rotating position of the at least one rolling member is in particular located, has a detent for the at least one rolling member. The rolling member is in particular in the maximum freely rotating position when the rolling member bears on the detent of the recess. Alternatively, it is also conceivable for the maximum angle between the clamping position and the maximum freely rotating position of the rolling member about the rotation axis of the freewheeling assembly to be more than 5°. A precise bidirectional freewheeling assembly which has a particularly fast response can advantageously be made available.

It is moreover proposed that the clamping element unit and the force transmission element have a common section plane which runs so as to be at least substantially perpendicular to a rotation axis, in particular the rotation axis already mentioned above, of the freewheeling assembly. “Substantially perpendicular” can be understood to mean an orientation of a direction relative to a reference direction, wherein the direction and the reference direction, in particular when viewed in a projection plane, enclose an angle of 90° and the angle has a maximum deviation of in particular less than 8°, advantageously less than 5°, and particularly advantageously less than 2°. The clamping element unit is preferably at least partially, preferably at least substantially completely, disposed within the force transmission element. An element being at least substantially completely disposed within a further element is to be understood to mean in particular that the element is disposed within the further element to an extent of at least 50%, preferably to an extent of at least 75%, and particularly preferably to an extent of at least 90%, of a total volume and/or a total mass of the element. The friction unit, in particular the spring unit, in at least one exemplary embodiment is particularly preferably disposed completely within the force transmission element. Alternatively, it is also conceivable for the clamping element unit to be disposed offset in relation to the force transmission element in the axial direction in such a manner that at least the external toothing of the force transmission element and the clamping element unit are free of a common section plane which runs so as to be at least substantially perpendicular to the rotation axis. A particularly compact drive device having a bidirectional freewheeling assembly which has a particularly rapid response can advantageously be made available. Damage to the clamping element unit, in particular contamination of the latter, can advantageously be counteracted.

It is furthermore proposed that a sum of a clamping element holding member angle and a spring angle is smaller than a sleeve clearance angle or is equal to the sleeve clearance angle. The clamping element holding member angle is in particular formed by a sum of a clamping element holding member clearance angle and a clamping element holding member load angle. The clamping element holding member angle is preferably at most 2.5°.

The clamping element holding member angle is particularly preferably substantially 1.8°. Alternatively however, it is also conceivable for the clamping element holding member angle to be more than 2.5°. The clamping element holding member clearance angle corresponds in particular to the maximum motion angle, in particular translatory angle, of the rolling member relative to the clamping element holding member about the rotation axis of the freewheeling assembly. The clamping element holding member load angle is in particular a sum of a mechanical clamping element holding member load angle and a chemical and/or thermal clamping element holding member load angle. The clamping element holding member load angle is preferably at most 1°. The clamping element holding member load angle is particularly preferably substantially 0.8°. Alternatively however, it is also conceivable for the clamping element holding member load angle to be more than 1°. The mechanical clamping element holding member load angle is in particular a function of potential mechanical deformations in terms of the clamping element holding member in the operation of the clamping element unit. The mechanical clamping element holding member load angle is preferably at most 0.7°. The mechanical clamping element holding member load angle is particularly preferably substantially 0.5°. Alternatively however, it is also conceivable for a value of the mechanical clamping element holding member load angle to be more than 0.7°. The chemical and/or thermal clamping element holding member load angle is in particular a function of the clamping element holding member in terms of a potential thermal expansion, a potential swelling of the material, for example as a result of absorbing moisture, or the like. The chemical and/or thermal clamping element holding member load angle is preferably at most 0.5°. The chemical and/or thermal clamping element holding member load angle is particularly preferably substantially 0.3°. Alternatively however, it is also conceivable for a value of the chemical and/or thermal clamping element holding member load angle to be more than 0.5°. The sleeve clearance angle preferably corresponds to the maximum angle between the clamping position of the at least one rolling member and the maximum freely rotating position of the at least one rolling member. A sum of the sleeve clearance angle and a sleeve load angle results in particular in a sleeve angle. The sleeve angle is preferably at most 6.5°, preferably at most 3.5°. The sleeve angle is particularly preferably substantially 3.3°. Alternatively however, it is also conceivable for the sleeve angle to be more than 6.5°. The sleeve load angle is preferably at least a function of a potential deformation and/or expansion of the force transmission element, in particular of the sleeve, preferably of the at least one clamping face, in the operation of the clamping element unit. The sleeve load angle is preferably at most 4°, preferably at most 2°. The sleeve load angle is most particularly preferably at least substantially 2.5°. Alternatively however, it is also conceivable for the sleeve load angle to have a value which is more than 4°. The spring angle is in particular a sum of a spring clearance angle and a spring load angle. The spring angle is preferably at most 0.1°. The spring angle is particularly preferably substantially 0.05°. Alternatively however, it is also conceivable for the spring angle to be more than 0.1°. The spring clearance angle relates in particular to potential play in the connection between the clamping element holding member and the spring unit, in particular the at least one spring element. The spring load angle is in particular a function of potential bending of the at least one spring element. The spring load angle is preferably at most 0.1°. The spring load angle is particularly preferably substantially 0.05°. Alternatively however, it is also conceivable for the spring load angle to be more than 1°. Particularly reliable functioning of the clamping element unit for the bidirectional freewheeling assembly can advantageously be implemented.

Furthermore proposed is a drive unit for an electric bicycle having a drive device according to the invention. The drive device is in particular at least partially, preferably at least to a major extent, disposed within the housing of the drive unit. The electric motor and/or the gearbox are/is preferably at least to a major extent disposed within the housing. A particularly robust and/or durable drive unit can advantageously be made available. The drive unit can advantageously be operated in a particularly gentle manner.

Furthermore proposed is an electric bicycle having a drive unit according to the invention. The drive unit, in particular the housing of the drive unit, is preferably fastened to the frame of the electric bicycle. The electric bicycle preferably comprises the wrapping means. It is conceivable that at least the housing of the drive unit is configured so as to be at least partially integral to at least one part of the frame. An electric bicycle having a bidirectional freewheeling assembly which has a particularly rapid response can advantageously be made available. A particularly precise travelling behaviour, in particular drive behaviour, can advantageously be implemented.

The drive device according to the invention, the drive unit according to the invention and/or the electric bicycle according to the invention are/is not intended here to be limited to the application and embodiment described above. The drive device according to the invention, the drive unit according to the invention and/or the electric bicycle according to the invention for fulfilling a functional mode described herein can in particular have a number deviating from a number of individual elements, components and units mentioned herein. Moreover, the ranges of values specified in this disclosure and values lying within said limits should be considered to be disclosed and able to be used in any desired manner.

### DRAWING

Further advantages are derived from the following description of the drawing. Eight exemplary embodiments of the invention are illustrated in the drawing. The drawing, the description and the claims contain numerous features in combination. The person skilled in the art will expediently also consider the features individually and combine them so as to form meaningful further combinations.

In the drawing:

FIG. 1 shows an electric bicycle according to the invention, having a drive unit according to the invention in a schematic illustration;

FIG. 2 shows a simplified schematic illustration of a drive device according to the invention of the drive unit;

FIG. 3 shows the drive unit in a perspective sectional illustration;

FIG. 4 shows the drive device in a perspective illustration;

FIG. 5 shows the drive device in an exploded illustration;

FIG. 6 shows a spring element of the drive device;

FIG. 7 shows a fragment of a drive device according to the invention of a first alternative embodiment in a schematic illustration;

FIG. 8 shows a fragment of a drive device according to the invention of a second alternative embodiment in a schematic sectional illustration;

FIG. 9 shows a drive device according to the invention of a third alternative embodiment in a schematic illustration;

FIG. 10 shows a drive device according to the invention of a fourth alternative embodiment in a perspective illustration;

FIG. 11 shows a fragment of a drive device according to the invention of a fifth alternative embodiment in a sectional illustration;

FIG. 12 shows part of a drive device according to the invention of a sixth alternative embodiment in a perspective illustration;

FIG. 13 shows a drive device according to the invention of a seventh alternative embodiment in a perspective illustration; and

FIG. 14 shows a spring element of the drive device from FIG. 13 in a perspective illustration.

### DESCRIPTION OF THE EXEMPLARY EMBODIMENTS

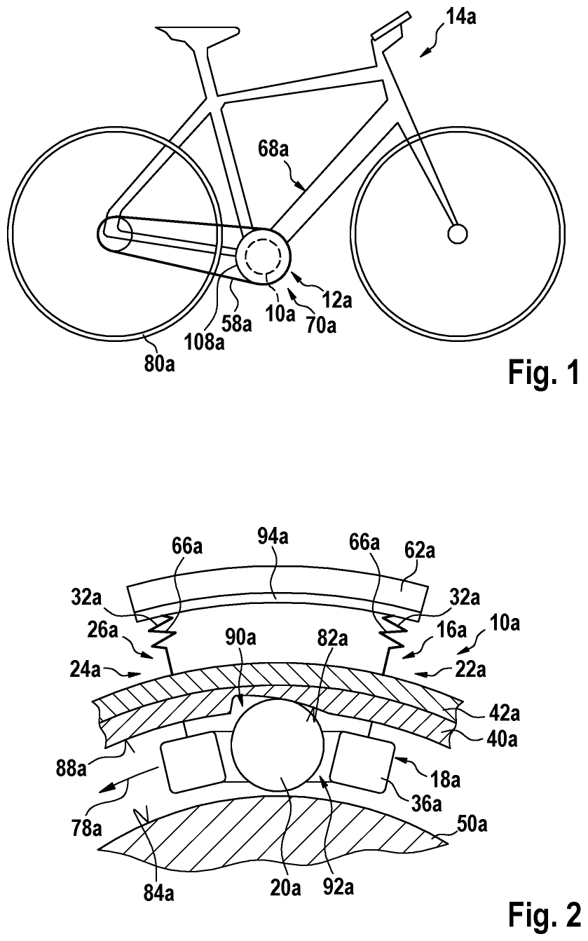

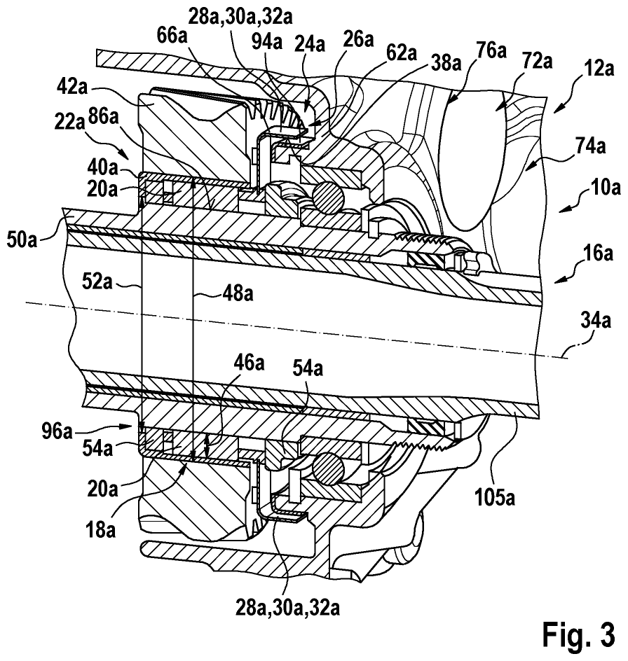

FIG. 1 shows an electric bicycle 14a. The electric bicycle 14a has a frame 68a. The electric bicycle 14a comprises a drive unit 12a. The drive unit 12a is disposed on the frame 68a. The drive unit 12a is disposed in a bottom bracket bearing region 70a of the electric bicycle 14a. The drive unit 12a comprises a housing 72a (cf. FIG. 3). The drive unit 12a comprises an electric motor 74a. The drive unit 12a comprises a gearbox 76a for transmitting a driving force of the drive unit 12a, in particular of the electric motor 74a, to an output sprocket 108a of the drive unit 12a. The output sprocket 108a is configured as a chainring or the like. The output sprocket 108a is connected to a gearbox output of the gearbox 76a.

The drive unit 12a comprises at least one drive device 10a. The drive device 10a is at least partially, preferably at least to a major extent, disposed within the housing 72a. FIG. 2 shows the construction of the drive device 10a in a simplified diagram. The drive device 10a has a bidirectional freewheeling assembly 16a. The freewheeling assembly 16a is configured as a force-fit-based freewheeling assembly. The freewheeling assembly 16a is configured so as to be different from a ratchet freewheeling assembly. The freewheeling assembly 16a has at least one clamping element unit 18a. The clamping element unit 18a is configured as a clamping roller unit. Alternatively however, it is also conceivable for the clamping element unit 18a to be configured as a clamping member unit or as a clamping ball unit. The clamping element unit 18a is disposed on the gearbox output of the drive unit 12a. Alternatively, it is also conceivable for the clamping element unit 18a to be disposed at another position within the gearbox 76a.

The drive unit 12a comprises at least one pedal crankshaft 105a. The pedal crankshaft 105a is able to be driven by a user by way of pedals (not illustrated). The output sprocket 108a is connected to the pedal crankshaft 105a in such a manner that the output sprocket 108a is able to be driven by a rotation of the pedal crankshaft 105a, in particular at least in one rotation direction, preferably in the direction of a forward rotation direction 78a of the drive device 10a. The forward rotation direction 78a corresponds to a forward movement of the electric bicycle 14a. It is conceivable for a shaft 50a to be connected to the pedal crankshaft 105a in a rotatably mounted manner. Additionally, it is conceivable for the drive unit 12a to have a further freewheeling assembly (not illustrated here) which is disposed between the shaft 50a and the pedal crankshaft 105a. The further freewheeling assembly is preferably provided to prevent conjoint rotation of the pedal crankshaft 105a in the case of a rotating shaft 50a. Alternatively, it is conceivable for the shaft 50a to be co-rotationally connected to the pedal crankshaft 105a. Alternatively, it is conceivable in particular for the shaft 50a to be configured so as to be integral to the pedal crankshaft 105a. Furthermore alternatively, it is conceivable for the shaft 50a to correspond to the pedal crankshaft 105a.

The drive device 10a comprises at least one force transmission element 42a for transmitting a driving force of the drive unit 12a. The clamping element unit 18a is disposed on the force transmission element 42a. The force transmission element 42a is configured as a spur gear. The spur gear has an external toothing. It is conceivable for the external toothing to be configured as a spur toothing or as a helical toothing. Alternatively however, it is also conceivable for the force transmission element 42a to be configured as a planet gear, as a ring gear, as a sun gear, or as any other force transmission element 42a considered expedient by a person skilled in the art. The force transmission element 42a forms the gearbox output of the drive unit 12a. Alternatively however, it is also conceivable for the force transmission element 42a to be disposed within the gearbox 76a and to be provided in particular for transmitting force to a layshaft of the gearbox 76a.

The drive device 10a comprises at least the shaft 50a. The shaft 50a is configured as an output shaft. Alternatively however, it is also conceivable for the shaft 50a to be configured as a layshaft, which is in particular disposed within the gearbox 76a, or the like. The output sprocket 108a is co-rotationally connected to the shaft 50a. It is conceivable for the output sprocket 108a to be configured so as to be integral to the shaft 50a.

The freewheeling assembly 16a has a rotation axis 34a. The shaft 50a and the force transmission element 42a are disposed coaxially about the rotation axis 34a (cf. also FIGS. 3, 4 and 5). The shaft 50a, the pedal crankshaft and/or the force transmission element 42a are/is mounted so as to be rotatable about the rotation axis 34a. A torque on the output sprocket 108a can be generated by rotating the shaft 50a about the rotation axis 34a. The clamping element unit 18a is specified to interrupt a transmission of a motor torque, which in terms of the forward direction of the electric bicycle 14a is directed forwards, to the shaft 50a, in particular the output sprocket 108a, when a rotating speed of the shaft 50a is higher than a rotating speed of the force transmission element 42a driven by the motor torque. The clamping element unit 18a is specified to interrupt a transmission of a motor torque, which in terms of the forward direction of the electric bicycle 14a is directed backwards, to the shaft 50a, in particular the output sprocket 108a, when the rotating speed of the shaft 50a, in particular of the output sprocket 108a, is higher than the rotating speed of the force transmission element 42a driven by the motor torque. The clamping element unit 18a is specified to interrupt a transmission of a torque of the shaft 50a, in particular of the output sprocket 108a, from the shaft 50a, in particular from the output sprocket 108a, to the force transmission element 42a, preferably the gearbox 76a and/or the electric motor 74a, when the shaft 50a, in particular the output sprocket 108a, in terms of the forward rotation direction 78a rotates backwards. The clamping element unit 18a is specified to interrupt the transmission of the torque of the shaft 50a, in particular of the output sprocket 108a, from the shaft 50a, in particular from the output sprocket 108a, to the force transmission element 42a, preferably to the gearbox 76a and/or the electric motor 74a, independently of the rotating speed of the force transmission element 42a and independently of the rotating speed of the shaft 50a, in particular of the output sprocket 108a.

The clamping element unit 18a is provided for decoupling vibrations of a wrapping means 58a. The wrapping means 58a is configured as a chain. Alternatively, it is also conceivable for the wrapping means 58a to be configured as a belt or the like. The wrapping means 58a is preferably co-rotationally connected to the output shaft, in particular the output sprocket 108a. The wrapping means 58a is provided to transmit a driving force from the shaft 50a, in particular from the output sprocket 108a, to a drive wheel 80a of the electric bicycle 14a. The drive wheel 80a is configured as a rear wheel of the electric bicycle 14a. Alternatively however, it is also conceivable for the drive wheel 80a to be configured as a front wheel of the electric bicycle 14a. The clamping element unit 18a is provided to counteract a transmission of vibrations of the wrapping means 58a to components of the drive unit 12a, which proceeding from the wrapping means 58a are disposed behind the clamping element unit 18a in the drivetrain. The clamping element unit 18a is provided to counteract a transmission of vibrations of the wrapping means 58a to the gearbox 76a and/or the electric motor 74a.

The clamping element unit 18a comprises a multiplicity of rolling members 20a (only one rolling member 20a is illustrated in the simplified schematic illustration in FIG. 2). It is also conceivable for the clamping element unit 18a to comprise only one rolling member 20a. The rolling members 20a are configured as rollers. Alternatively, it is also conceivable for the rolling members 20a to be configured as balls, as drums, as needles, as cones, or as other rotation members considered expedient by a person skilled in the art. The rolling members 20a in a clamping position of the rolling members 20a are provided for transmitting torque between the force transmission element 42a and the shaft 50a. The rolling members 20a in a freely rotating position of the rolling members 20a are provided for interrupting a transmission of torque between the force transmission element 42a and the shaft 50a.

The clamping element unit 18a comprises at least one sleeve 40a. The sleeve 40a is disposed on the force transmission element 42a. The sleeve 40a is co-rotationally connected to the force transmission element 42a. It is conceivable for the sleeve 40a to be configured so as to be integral to the force transmission element 42a. It is also conceivable that the sleeve 40a is formed by the force transmission element 42a. The rolling members 20a are disposed between the force transmission element 42a, in particular the sleeve 40a, and the shaft 50a. The rolling members 20a are uniformly disposed. The rolling members 20a are disposed uniformly along a circumferential direction of the shaft 50a, which runs in particular in the plane perpendicular to the rotation axis 34a.

The clamping element unit 18a has at least one clamping face 82a, preferably a multiplicity of clamping faces 82a. The sleeve 40a comprises the at least one clamping face 82a. The clamping face 82a is provided to interact with at least one of the rolling members 20a so as to transmit torque between the force transmission element 42a and the shaft 50a. The clamping element unit 18a has at least one further clamping face 84a. The further clamping face 84a is provided to interact with at least one of the rolling members 20a so as to transmit torque between the force transmission element 42a and the shaft 50a. The shaft 50a has a circular-cylindrical shell face 86a. The further clamping face 84a is formed by the circular-cylindrical shell face 86a of the shaft 50a. The sleeve 40a has an internal face 88a. The internal face 88a faces the shaft 50a. The internal face 88a comprises the at least one clamping face 84. A number of clamping faces 82a corresponds to the number of rolling members 20a. The rolling members 20a are in each case assigned one of the clamping faces 82a.

The rolling members 20a are in each case provided to be clamped by one of the clamping faces 82a and the further clamping faces 84a so as to transmit torque between the force transmission element 42a and the shaft 50a. The sleeve 40a has at least a multiplicity of recesses 90a for disposing the rolling members 20a (only one recess 90a is illustrated in the simplified schematic illustration in FIG. 2). A number of recesses 90a corresponds to a number of rolling members 20a. One of the clamping faces 82a is in each case disposed in the recesses 90a. The recesses 90a are configured so as to be asymmetrical, in particular at least when viewed in a circumferential direction of the force transmission element 42a, which preferably lies in a plane which runs perpendicularly to the rotation axis 34a. The recesses 90a are configured in such a manner that the rolling members 20a can in each case be disposed in the recesses 90a in a clamping position on the clamping face 82a and in a freely rotating position.

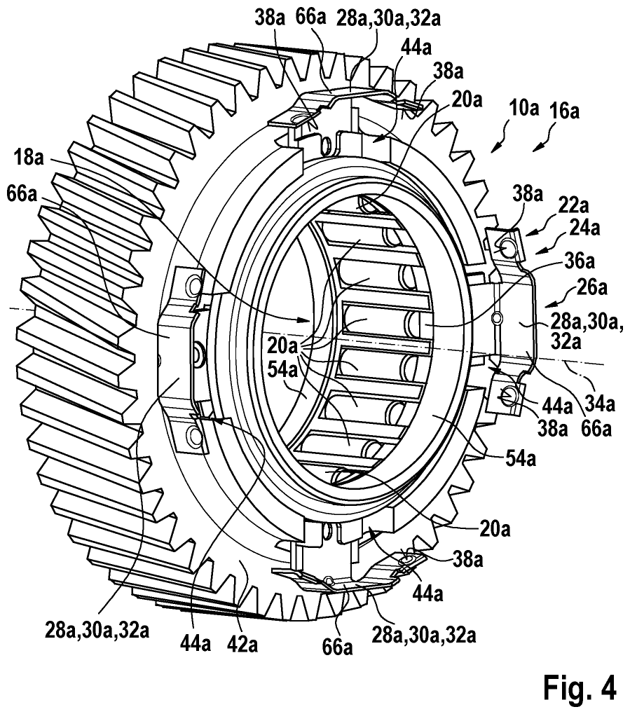

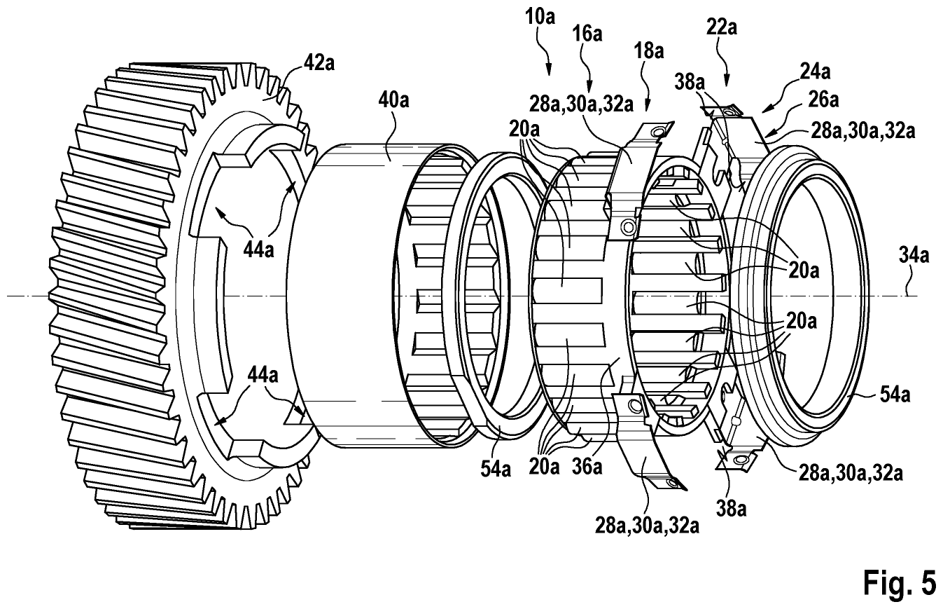

The clamping element unit 18a comprises at least one clamping element holding member 36a (the clamping element holding member 36a is illustrated in a schematically simplified manner in FIG. 2). The clamping element holding member 36a has a multiplicity of receptacle regions 92a for the rolling members 20a. The clamping element holding member 36a is configured so as to be annular (cf. also FIGS. 4 and 5). The clamping element holding member 36a is configured as a cage ring. A number of receptacle regions 92a corresponds to the number of rolling members 20a. The receptacle regions 92a are separate from one another. The receptacle regions 92a delimit a movement of the rolling members 20a, in particular about the rotation axis 34a, preferably in the circumferential direction, relative to the clamping element holding member 36a. The clamping element holding member 36a is disposed between the shaft 50a and the force transmission element 42a, in particular the sleeve 40a. The clamping element holding member 36a is disposed so as to be movable relative to the force transmission element 42a, in particular the sleeve 40a, and/or the shaft 50a. The clamping element holding member 36a is provided to guide the rolling members 20a.

The clamping element unit 18a comprises a mechanical control unit 22a. The control unit 22a is provided to change between a freewheeling state and a torque-transmitting state of the freewheeling assembly 16a. The freewheeling state is a state of the freewheeling assembly 16a in which a transmission of torque between the force transmission element 42a and the shaft 50a is interrupted. The torque-transmitting state is a state of the freewheeling assembly 16a in which a transmission of torque between the force transmission element 42a and the shaft 50a takes place. A changeover between the freewheeling state and the torque-transmitting state by means of the control unit 22a takes place automatically, in particular so as to be free of any intervention by a user and/or free of electronic control. The control unit 22a is free of electrical components. Alternatively however, it is also conceivable for the clamping element unit 18a to comprise an electronic control unit.

The control unit 22a has a friction unit 24a which is provided for generating an actuating force. The friction unit 24a is provided for moving the clamping element holding member 36a relative to the force transmission element 42a and/or the shaft 50a, in particular for rotating said clamping element holding member about the rotation axis 34a. The friction unit 24a is at least provided for releasing a torque-transmitting state of the freewheeling assembly 16a, as a function of a relative movement of the force transmission element 42a to the shaft 50a. The friction unit 24a, as a function of a relative movement of the force transmission element 42a to the shaft 50a, is at least provided to switch the freewheeling assembly 16a by the actuating force from the torque-transmitting state of the freewheeling assembly 16a to the freewheeling state of the freewheeling assembly 16a. The friction unit 24a is provided to position the rolling members 20a relative to the force transmission element 42a, in particular the sleeve 40a, and/or the shaft 50a, preferably so as to switch the freewheeling assembly 16a, preferably at least from the torque-transmitting state to the freewheeling state.

The friction unit 24a is provided to generate a frictional force between the clamping element holding member 36a and a friction member 94a which is configured separately from the clamping element holding member 36a. The friction member 94a is a stationary component of the freewheeling assembly 16a. The friction member 94a is configured as a friction ring. The friction member 94a is co-rotationally connected to a housing component 62a of the housing 72a. Alternatively, it is also conceivable for the friction member 94a to be formed by a stationary component of the electric bicycle 14a, in particular of the drive unit 12a. Alternatively, the friction member 94a is configured, for example, by the housing component 62a, by a frame element of the frame 68a, or the like. Frictional contact between the clamping element holding member 36a and the friction member 94a is formed by the friction unit 24a. The friction unit 24a has a multiplicity of friction elements 66a (only two friction elements 66a are illustrated in the simplified schematic illustration in FIG. 2). The friction unit 24a has four friction elements 66a. Alternatively, it is also conceivable for the friction unit 24a to have a number of friction elements 66a which differs from four, for example one friction element 66a, two friction elements 66a, three friction elements 66a, or more than four friction elements 66a. The friction elements 66a are provided for forming the frictional contact between the clamping element holding member 36a and the friction member 94a. The friction elements 66a are disposed in the circumferential direction of the clamping element holding member 36a, which runs in particular in a plane perpendicular to the rotation axis 34a.

The friction elements 66a have in each case two friction faces 38a for forming the frictional contact between the clamping element holding member 36a and the friction member 94a. Alternatively, it is also conceivable for the friction elements 66a to have in each case only one friction face 38a or more than two friction faces 38a. Alternatively however, it is also conceivable for the friction elements 66a to be disposed non-uniformly in the circumferential direction, preferably on the clamping element holding member 36a or the friction member 94a. The friction elements 66a are fastened to the clamping element holding member 36a. The friction elements 66a are configured so as to be integral to the clamping element holding member 36a.

The actuating force is a frictional force. The friction unit 24a, in at least one operating state of the freewheeling assembly 16a, is provided to generate the actuating force by static friction and/or dynamic friction between the clamping element holding member 36a and the friction member 94a. The actuating force, in particular the frictional force, at least in the operating state of the freewheeling assembly 16a, acts counter to a torque prevailing on the clamping element holding member 36a. The actuating force, preferably the frictional force, is provided to decelerate a rotation of the clamping element holding member 36a about the rotation axis 34a relative to the shaft 50a, in particular at least in the freewheeling state.

The drive device 10a comprises at least one bearing unit 96a which is at least partially disposed between the force transmission element 42a, in particular the sleeve 40a, and the shaft 50a. The bearing unit 96a is at least provided to mount the force transmission element 42a and the shaft 50a so as to be mutually rotatable and/or at a fixed radial spacing relative to one another. The bearing unit 96a comprises at least two bearing elements 54a. Alternatively, it is also conceivable for the bearing unit 96a to comprise only one bearing element 54a or more than two bearing elements 54a. The bearing elements 54a are configured as plain bearing rings. The bearing elements 54a are disposed between the force transmission element 42a, in particular the sleeve 40a, and the shaft 50a.

The clamping element unit 18a, by means of the respective clamping face 82a, is specified to clamp the rolling members 20a in the recesses 90a when the rotating speed of the force transmission element 42a in the forward rotation direction 78a is higher than or is equal to the rotating speed of the shaft 50a. The friction unit 24a, during a rotation of the force transmission element 42a in the forward rotation direction 78a, wherein a rotating speed of the force transmission element 42a is higher than a rotating speed of the shaft 50a, by means of the actuating force, in particular the frictional force, is provided to brake the clamping element holding member 36a relative to the force transmission element 42a, so as to bring into contact the rolling members 20a with the clamping faces 82a in the recesses 90a of the sleeve 40a, and to clamp said rolling members 20a. The clamping element unit 18a, by way of the actuating force, in particular the frictional force, in a rotation direction of the shaft 50a which in terms of the forward rotation direction 78a is directed backwards, is provided to generate a force on the rolling members 20a so as to release the rolling members 20a from the clamping faces 82a such that the freewheeling assembly 16a is switched to the freewheeling state. Clamping of the rolling members 20a by way of the force transmission element 42a, in particular the sleeve 40a, and the shaft 50a can be generated by the actuating force, in particular the frictional force, when the rotating speed of the force transmission element 42a is higher than the rotating speed of the shaft 50a, preferably at least in a rotation of the force transmission element 42a which in terms of the forward rotation direction 78a is directed forwards. As a result of the clamping of the rolling members 20a by way of the force transmission element 42a, in particular the sleeve 40a, and the shaft 50a, a torque is able to be transmitted between the force transmission element 42a and the shaft 50a.

The rolling members 20a in the torque-transmitting state are co-rotationally connected to the force transmission element 42a, in particular the sleeve 40a, and the shaft 50a. The rolling members 20a are in particular in the clamping position when the freewheeling assembly 16a is in the torque-transmitting state. The rolling members 20a in the freewheeling state are disposed so as to rotate freely in the recesses 90a. The rolling members 20a are in particular in the freely rotating position when the freewheeling assembly 16a is in the freewheeling state. The rolling members 20a are in each case disposed so as to freely rotate in the recesses 90a when the shaft 50a in terms of the forward rotation direction 78a rotates backwards. The rolling members 20a are in each case disposed so as to freely rotate in the recesses 90a when the shaft 50a in terms of the forward rotation direction 78a rotates forwards and the rotating speed of the shaft 50a is higher than the rotating speed of the force transmission element 42a. The rolling members 20a are in each case disposed so as to freely rotate in the recesses 90a when the force transmission element 42a in terms of the forward rotation direction 78a rotates backwards. The clamping element unit 18a, by means of the clamping element holding member 36a, is provided to release the rolling members 20a from the clamping action when the rotating speed of the shaft 50a is higher than the rotating speed of the force transmission element 42a.

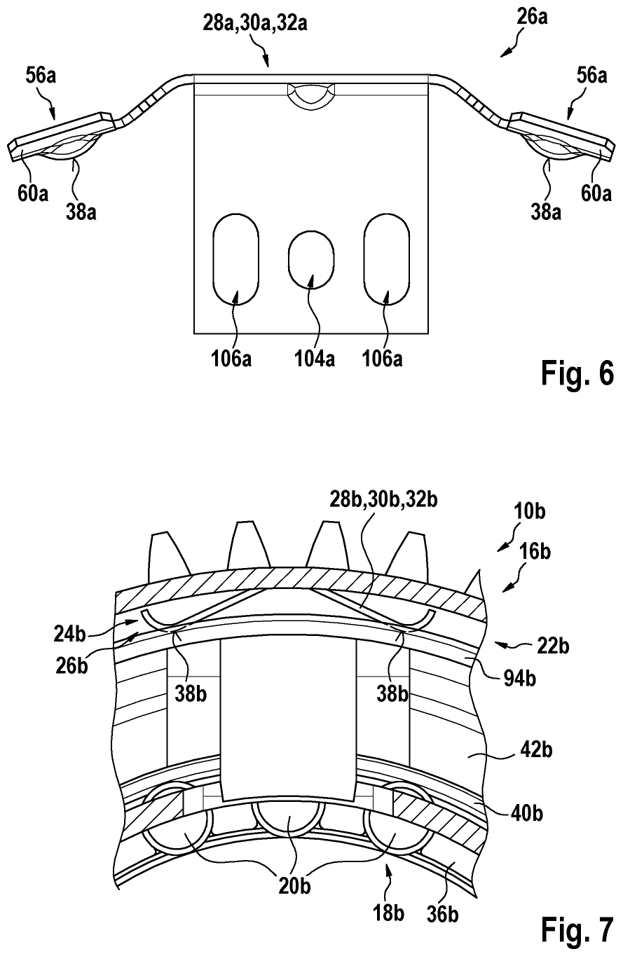

The friction unit 24a comprises at least one spring unit 26a. The clamping element holding member 36a is connected to the friction member 94a by way of the spring unit 26a. The spring unit 26a is provided to generate a holding force between the clamping element holding member 36a and the friction member 94a. The spring unit 26a is provided to generate the actuating force, in particular the frictional force, of the friction unit 24a. The spring unit 26a has four spring elements 32a. Alternatively however, it is also conceivable for the spring unit 26a to have a number of spring elements 32a which differs from four, for example only one spring element 32a, two spring elements 32a, three spring elements 32a, or more than four spring elements 32a. The friction elements 66a are formed by the spring elements 32a. The spring elements 32a are configured as flexible springs 28a. Alternatively, it is also conceivable for the spring elements 32a to be configured as torsion springs, as plate springs, as volute springs, as annular springs, or the like. Furthermore alternatively, it is also conceivable for the spring elements 32a to be configured as rubber-elastic elements. The spring elements 32a are disposed on the clamping element holding member 36a. The spring elements 32a are disposed between the clamping element holding member 36a and the friction member 94a. The clamping element holding member 36a is connected to the friction member 94a by way of the spring elements 32a. The four spring elements 32a have in each case two assembly ramps 60a (cf. FIG. 6). The assembly ramps 60a are formed by faces which are angled in relation to the rotation axis 34a and run preferably in a manner other than perpendicular.

The flexible springs 28a are configured as leaf springs 30a. Alternatively, it is also conceivable for the flexible springs 28a to be configured as wire springs, as needle springs, as leg springs, or the like. The spring unit 26a is preferably configured so as to be free of coil springs. The leaf springs 30a are configured as leaf springs having at least two arms. Alternatively however, it is also conceivable for the leaf springs 30a to be configured as single-arm leaf springs, as spiral springs, as cushioning springs, as elliptic springs, as parabolic springs, as serpentine springs, or as other leaf springs 30a considered expedient by a person skilled in the art. The leaf springs 30a have in each case two spring arms 56a (cf. FIG. 6). The friction faces 38a of the friction elements 66a are in each case disposed on the spring arms 56a.

The rolling members 20a are disposed without springs on the clamping element holding member 36a. The receptacle regions 92a for the rolling members 20a are free of spring elements. In particular, a region between the rolling members 20a and the clamping element holding member 36a, preferably at least in the respective receptacle region 92a, is free of spring elements. The rolling members 20a are free of any mounting on the clamping element holding member 36a by means of spring elements.

The spring elements 32a are fastened to the clamping element holding member 36a. The spring elements 32a are formed from a material which differs from a material from which the clamping element holding member 36a is formed. The spring elements 32a are formed from metal. Alternatively however, it is also conceivable for the spring elements 32a to be formed from a plastics material or any other material considered expedient by a person skilled in the art. The clamping element holding member 36a is formed from a plastics material. Alternatively however, it is also conceivable for the clamping element holding member 36a to be formed from a metal or any other material considered expedient by a person skilled in the art. Alternatively however, it is also conceivable for the spring elements 32a and the clamping element holding member 36a to be configured from an identical material. The spring elements 32a are configured so as to be integral to the clamping element holding member 36a. The spring elements 32a are overmoulded by the clamping element holding member 36a. The spring elements 32a are at least partially overmoulded by the clamping element holding member 36a.

The spring elements 32a have in each case two connection elements 106a so as to connect the spring elements 32a to the clamping element holding member 36a. The connection elements 106a are configured as openings. Alternatively however, it is also conceivable for the connection elements 106a to be configured as other connection elements 106a considered expedient by a person skilled in the art. The connection elements 106a are provided to be penetrated by the clamping element holding member 36a by injection moulding in the case of production of the clamping element unit 18a. The spring elements 32a have in each case one assembly element 104a. The respective assembly element 104a is provided to support an arrangement of the spring elements 32a on the clamping element holding member 36a in an assembly position prior to overmoulding. The assembly elements 104a are configured as openings. Alternatively however, it is also conceivable for the assembly elements 104a to be configured as protrusions or as other assembly elements 104a considered expedient by a person skilled in the art.

The friction faces 38a of the friction unit 24a, in particular of the friction elements 66a, extend in the axial direction. The axial direction runs parallel to the rotation axis 34a. The friction faces 38a are at least partially curved. Alternatively or additionally, it is conceivable for the friction faces 38a to at least partially run in a rectilinear manner. The friction faces 38a have in each case a plane of main extent which runs so as to be at least substantially parallel to the axial direction.

When viewed in the axial direction, the friction faces 38a which extend in the axial direction are disposed on a side that faces away from the clamping element holding member 36a. The spring arms 56a of the spring elements 32a are disposed on the side that faces away from the clamping element holding member 36a, in particular at least when viewed in the axial direction. When viewed in the radial direction, the friction faces 38a which extend in the axial direction are oriented inwards. The friction faces 38a are disposed so as to face the shaft 50a. The friction faces 38a are disposed so as to face the rotation axis 34a.

The force transmission element 42a has four lead throughs 44a by way of which the clamping element holding member 36a in the radial direction is at least partially guided towards the outside. Alternatively, it is also conceivable for the force transmission element 42a to have a number of lead throughs 44a which differs from four, for example only one lead through 44a, two, three, or more than four lead throughs 44a. A number of lead throughs 44a corresponds in particular to a number of friction elements 66a, in particular spring elements 32a. Alternatively however, it is also conceivable for the number of lead throughs 44a to differ from a number of friction elements 66a, in particular spring elements 32a.

A value of a maximum diameter 46a of the rolling members 20a is between 6% and 20% of a value of a maximum internal diameter 48a of the force transmission element 42a, in particular the sleeve 40a. A value of the maximum diameter 46a of the rolling members 20a preferably is at most 15%, particularly preferably at most 10%, of a value of the maximum internal diameter 48a of the force transmission element 42a, in particular the sleeve 40a. Alternatively however, it is also conceivable that a value of the maximum diameter 46a of the rolling members 20a is outside a range between 6% and 20% of a value of the maximum internal diameter 48a of the force transmission element 42a, in particular the sleeve 40a.

The internal diameter 48a is in particular measured in the radial direction. The maximum diameter 46a is preferably measured in the radial direction. A value of the maximum diameter 46a of the rolling members 20a is between 8% and 25% of a value of a maximum diameter 52a of the shaft 50a. A value of the maximum diameter 46a of the rolling members 20a is preferably at most 15%, particularly preferably at most 12%, of a value of the maximum diameter 52a of the shaft 50a. Alternatively however, it is also conceivable for a value of the maximum diameter 46a of the rolling members 20a to be outside a range between 8% and 25% of a value of the maximum diameter 52a of the shaft 50a. The maximum diameter 52a of the shaft 50a is in particular measured in the radial direction.

A value of the maximum diameter 52a of the shaft 50a is, for example, at most 38 mm; a value of the maximum diameter 52a of the shaft 50a is particularly preferably 32 mm. A value of the maximum internal diameter 48a of the force transmission element 42a, in particular of the sleeve 40a, is at most 45 mm. A value of the maximum internal diameter 48a of the force transmission element 42a, in particular of the sleeve 40a, is preferably between 40 mm and 41 mm. Alternatively however, it is also conceivable for a value of the maximum internal diameter 48a of the force transmission element 42a, in particular of the sleeve 40a, to be more than 45 mm. A value of the maximum diameter 46a of the rolling members 20a is at most 5 mm. A value of the maximum diameter 46a of the rolling members 20a is preferably substantially 3.5 mm. Alternatively however, it is also conceivable for a value of the maximum diameter 46a of the rolling members 20a to be more than 5 mm.

A respective maximum motion angle, in particular a translatory angle, of the rolling members 20a relative to the clamping element holding member 36a about the rotation axis 34a of the freewheeling assembly 16a is at most 1.5°. The maximum motion angle, in particular translatory angle, of the rolling members 20a relative to the clamping element holding member 36a is preferably between 0° and 1°. The respective maximum motion angle, in particular translatory angle, of the rolling members 20a relative to the clamping element holding member 36a is particularly preferably substantially 0.5°. Alternatively however, it is also conceivable for the respective maximum motion angle, in particular translatory angle, of the rolling members 20a relative to the clamping element holding member 36a about the rotation axis 34a to be more than 1.5°.

A maximum angle between the respective clamping position of the rolling members 20a and a respective maximum freely rotating position of the rolling members 20a about the rotation axis 34a of the freewheeling assembly 16a is at most 5°. The maximum angle between the respective clamping position of the rolling members 20a and the respective maximum freely rotating position of the rolling members 20a about the rotation axis 34a of the freewheeling assembly 16a is preferably at most 2.5°. The maximum angle between the respective clamping position of the rolling members 20a and the respective maximum freely rotating position of the rolling members 20a about the rotation axis 34a of the freewheeling assembly 16a is preferably between 0.3° and 2.5°, particularly preferably between 0.4° and 2°. The maximum angle between the respective clamping position of the rolling members 20a and the respective maximum freely rotating position of the rolling members 20a about the rotation axis 34a is most particularly preferably at least substantially 0.8°. The respective maximum freely rotating position and the respective clamping position of the rolling members 20a are in each case located in one of the recesses 90a for the rolling members 20a. The respective maximum freely rotating position and the clamping position are located at mutually opposite end regions of the recesses 90a. The clamping faces 82a are in each case disposed on a rear side of the recesses 90a in terms of the forward rotation direction 78a. The respective freely rotating position is disposed on a front side of the recesses 90a in terms of the forward rotation direction 78a. The recesses 90a, in the respective end region in which the freely rotating position of the respective rolling member 20a is in particular located, have a detent for the respective rolling member 20a. Alternatively, it is also conceivable for the maximum angle between the respective clamping position and the respective maximum freely rotating position of the rolling members 20a about the rotation axis 34a of the freewheeling assembly 16a to be more than 5°. The rolling members 20a are in each case in the maximum freely rotating position when the rolling members 20a bear on the respective detent of the recesses 90a.

The clamping element unit 18a and the force transmission element 42a have a common section plane which runs so as to be at least substantially perpendicular to the rotation axis 34a. The clamping element unit 18a is disposed so as to be at least substantially completely within the force transmission element 42a. Alternatively, it is also conceivable for the clamping element unit 18a to be disposed offset in relation to the force transmission element 42a in the axial direction in such a manner that at least the external toothing of the force transmission element 42a and the clamping element unit 18a are free of a common section plane which runs so as to be at least substantially perpendicular to the rotation axis 34a.

A sum of a cage angle and a spring angle is smaller than a sleeve clearance angle or equal to the sleeve clearance angle. The clamping element holding member angle is formed by a sum of a clamping element holding member clearance angle and a clamping element holding member load angle. The clamping element holding member angle is at most 2.5°. The clamping element holding member angle is particularly preferably substantially 1.8°. Alternatively however, it is also conceivable for the clamping element holding member angle to be more than 2.5°. The clamping element holding member clearance angle corresponds to the respective maximum motion angle, in particular translatory angle, of the rolling members 20a relative to the clamping element holding member 36a about the rotation axis 34a of the freewheeling assembly 16a. The clamping element holding member load angle is a sum of a mechanical clamping element holding member load angle and a chemical and/or thermal clamping element holding member load angle. The clamping element holding member load angle is at most 1°. The clamping element holding member load angle is particularly preferably substantially 0.8°. Alternatively however, it is also conceivable for the clamping element holding member load angle to be more than 1°. The mechanical clamping element holding member load angle is in particular a function of potential mechanical deformations in terms of the clamping element holding member 36a in the operation of the clamping element unit 18a. The mechanical clamping element holding member load angle is at most 0.7°. The mechanical clamping element holding member load angle is particularly preferably substantially 0.5°. Alternatively however, it is also conceivable for a value of the mechanical clamping element holding member load angle to be more than 0.7°. The chemical and/or thermal clamping element holding member load angle is in particular a function of the clamping element holding member 36a in terms of a potential thermal expansion, a potential swelling of the material, for example as a result of absorbing moisture, or the like. The chemical and/or thermal clamping element holding member load angle is at most 0.5°. The chemical and/or thermal clamping element holding member load angle is particularly preferably substantially 0.3°. Alternatively however, it is also conceivable for a value of the chemical and/or thermal clamping element holding member load angle to be more than 0.5°.

The sleeve clearance angle preferably corresponds to the respective maximum angle between the respective clamping position of the rolling members 20a and the respective maximum freely rotating position of the rolling members 20a. A sum of the sleeve clearance angle and a sleeve load angle results in particular in a sleeve angle. The sleeve angle is at most 6.5°, preferably at most 3.5°. The sleeve angle particularly preferably is substantially 3.3°. Alternatively however, it is also conceivable for the sleeve angle to be more than 6.5°.The sleeve load angle is preferably at least a function of a potential deformation and/or expansion of the force transmission element 42a, in particular the sleeve 40a, preferably the clamping faces 82a, in the operation of the clamping element unit 18a. The sleeve load angle is at most 4°, preferably at most 2°. The sleeve load angle is very particularly preferably at least substantially 2.5°. Alternatively however, it is also conceivable for the sleeve load angle to have a value which is more than 4°. The spring angle is in particular a sum of a spring clearance angle and a spring load angle. The spring angle is at most 0.1°. The spring angle is particularly preferably substantially 0.05°. Alternatively however, it is also conceivable for the spring angle to be more than 0.1°. The spring clearance angle relates in particular to potential play in the connection between the clamping element holding member 36a and the spring unit 26a, in particular the spring elements 32a. The spring load angle is in particular a function of potential bending of the respective spring elements 32a. The spring load angle is preferably at most 0.1°. The spring load angle is particularly preferably substantially 0.05°. Alternatively however, it is also conceivable for the spring load angle to be more than 1°. A freewheeling function angle is in particular a sum of the sleeve angle, the clamping element holding member angle and the spring angle.

Further exemplary embodiments of the invention are shown in FIGS. 7 to 14. The descriptions hereunder and the drawings are substantially limited to the points of differentiation between the exemplary embodiments, wherein reference in terms of identically denoted components, in particular in terms of components with identical reference signs, can in principle also be made to the drawings and/or the description of the other exemplary embodiments, in particular of FIGS. 1 to 6. In order for the exemplary embodiments to be differentiated, the suffix a is added to the reference signs of the exemplary embodiment in FIGS. 1 to 6. In the exemplary embodiments of FIGS. 7 to 14, the suffix a is replaced by the letters b to h.

FIG. 7 shows a drive device 10b for a drive unit (not illustrated here) of an electric bicycle (not illustrated here). The drive device 10b has a bidirectional freewheeling assembly 16b. The freewheeling assembly 16b has at least one clamping element unit 18b. The clamping element unit 18b comprises at least one mechanical control unit 22b. The control unit 22b has at least one friction unit 24b which is provided to generate an actuating force. The friction unit 24b has at least one spring unit 26b. The freewheeling assembly 16b has at least one friction member 94b. The drive device 10b comprises at least one force transmission element 42b for transmitting a driving force of the drive unit.

The spring unit 26b has four spring elements 32b which are configured separately from a clamping element holding member 36b of the clamping element unit 18b (only one of the four spring elements 32b is illustrated in FIG. 7). The spring elements 32b are disposed between the friction member 94b and the clamping element holding member 36b. The spring elements 32b are braced between the friction member 94b and the clamping element holding member 36b. The spring elements 32b are able to be flexibly disposed along a circumferential direction of the friction member 94b and/or of the clamping element holding member 36b between the clamping element holding member 36b and the friction member 94b, and are in particular able to be clamped for fixing. Alternatively, it is also conceivable for the spring elements 32b to be fastened to the clamping element holding member 36b or to be fastened to the friction member 94b, in particular to be configured so as to be integral to the friction member 94b. The spring elements 32b are configured as flexible springs 28b, in particular as leaf springs 30b. The friction unit 24b has friction faces 38b. The friction faces 38b are disposed on the spring elements 32b. The friction faces 38b are oriented radially inwards. The spring elements 32b are in particular formed from a material which is different from a material from which the clamping element holding member 36b is configured. Alternatively however, it is also conceivable for the material from which the spring elements 32b are formed to correspond to the material from which the clamping element holding member 36b is formed. The clamping element unit 18b comprises at least one sleeve 40b. The clamping element unit 18b comprises a multiplicity of rolling members 20b.

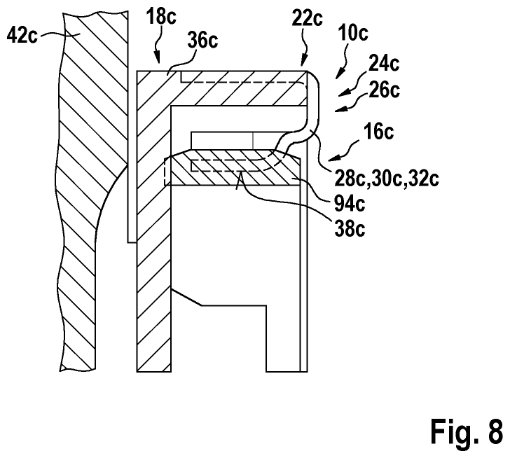

FIG. 8 shows a drive device 10c for a drive unit (not illustrated here) of an electric bicycle (not illustrated here). The drive device 10c has a bidirectional freewheeling assembly 16c. The freewheeling assembly 16c has at least one clamping element unit 18c. The clamping element unit 18c comprises at least one mechanical control unit 22c. The control unit 22c has at least one friction unit 24c which is provided to generate an actuating force. The friction unit 24c has at least one spring unit 26c. The freewheeling assembly 16c has at least one friction member 94c. The drive device 10c comprises at least one force transmission element 42c for transmitting a driving force of the drive unit. The spring unit 26c has four spring elements 32c. The spring elements 32c are configured separately from a clamping element holding member 36c of the clamping element unit 18c. The spring elements 32c are configured as flexible springs 28c, in particular as leaf springs 30c. The friction member 94c in the radial direction is externally surrounded by the clamping element holding member 36c. Friction faces 38c of the friction unit 24c point radially inwards.

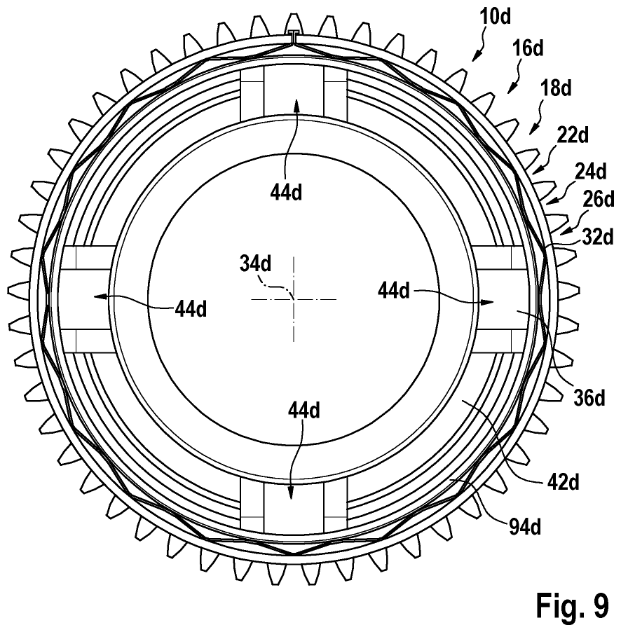

FIG. 9 shows a drive device 10d for a drive unit (not illustrated here) of an electric bicycle (not illustrated here). The drive device 10d has a bidirectional freewheeling assembly 16d. The freewheeling assembly 16d has at least one clamping element unit 18d. The clamping element unit 18d comprises at least one clamping element holding member 36d. The freewheeling assembly 16d has at least one friction member 94d. The drive device 10d comprises at least one force transmission element 42d for transmitting a driving force of the drive unit. The force transmission element 42d has four lead throughs 44d by way of which the clamping element holding member 36d in the radial direction is at least partially guided towards the outside.

The clamping element unit 18d comprises at least one mechanical control unit 22d. The control unit 22d has at least one friction unit 24d which is provided to generate an actuating force. The friction unit 24d has at least one spring unit 26d. The spring unit 26d comprises a spring element 32d. The spring element 32d surrounds a rotation axis 34d of the freewheeling assembly 16d at least to a major extent. The spring element 32d is configured so as to be annular. The spring element 32d along the main extent thereof has portions 98d which are angled in relation to one another and run in a rectilinear manner (by way of example, only three of the portions 98d are provided with reference signs in FIG. 9).

Alternatively or additionally, it is also conceivable for the spring element 32d along the main extent thereof to run so as to be at least partially curved. The spring element 32d, the clamping element holding member 36d, the force transmission element 42d and the friction member 94d are disposed so as to be coaxial with the rotation axis 34d.

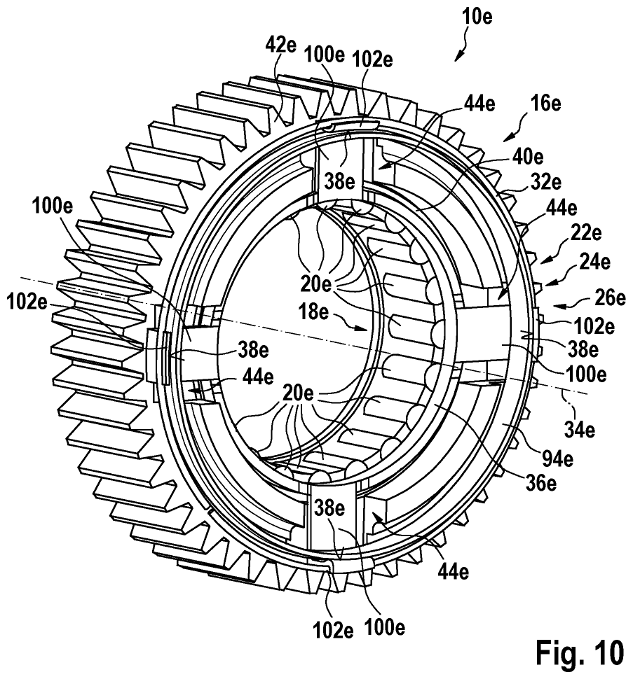

FIG. 10 shows a drive device 10e for a drive unit (not illustrated here) of an electric bicycle (not illustrated here). The drive device 10e has a bidirectional freewheeling assembly 16e. The freewheeling assembly 16e has at least one clamping element unit 18e. The clamping element unit 18e comprises at least one clamping element holding member 36e. The freewheeling assembly 16e has at least one friction member 94e. The drive device 10e comprises at least one force transmission element 42e for transmitting a driving force of the drive unit. The force transmission element 42e has four lead throughs 44e by way of which the clamping element holding member 36e in the radial direction is at least partially guided towards the outside. The clamping element unit 18e comprises at least one sleeve 40e.

The clamping element unit 18e comprises at least one mechanical control unit 22e. The control unit 22e has at least one friction unit 24e which is provided to generate an actuating force. The friction unit 24e has at least one spring unit 26e. The spring unit 26e comprises a spring element 32e. The spring element 32e surrounds a rotation axis 34e of the freewheeling assembly 16e at least to a major extent. The spring element 32e is configured so as to be annular. The spring element 32e along the main extent thereof has an, in particular continuous, curved profile. Friction faces 38e of the friction unit 24e are formed by the clamping element holding member 36e. The clamping element holding member 36e has four finger elements 100e. Alternatively, it is also conceivable for the clamping element holding member 36e to have a number of finger elements 100e which differs from four, for example one, two, three or more than four finger element(s) 100e. The finger elements 100e in the radial direction are guided towards the outside by way of the lead throughs 44e. The finger elements 100e have in each case one clamping protrusion 102e on a respective free end of the finger elements 100e. The spring element 32e bears on the clamping protrusions 102e. The spring element 32e by way of the clamping protrusions 102e exerts a holding force on the friction member 94e. The actuating force, in particular a frictional force, in particular between the clamping element holding member 36e and the friction member 94e, is able to be generated by the spring element 32e by way of the clamping element holding member 36e.

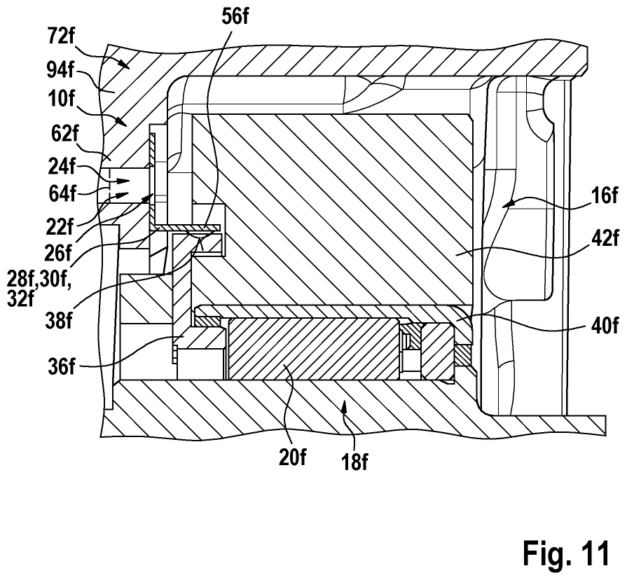

FIG. 11 shows a drive device 10f for a drive unit (not illustrated here) of an electric bicycle (not illustrated here). The drive device 10f has a bidirectional freewheeling assembly 16f. The freewheeling assembly 16f has at least one clamping element unit 18f. The drive device 10f comprises at least one force transmission element 42f for transmitting a driving force of the drive unit. The clamping element unit 18f comprises at least one sleeve 40f. The clamping element unit 18f comprises a multiplicity of rolling members 20f (only one of the rolling members 20f is illustrated in FIG. 11).

The clamping element unit 18f comprises at least one mechanical control unit 22f. The control unit 22f has at least one friction unit 24f which is provided to generate an actuating force. The friction unit 24f has at least one spring unit 26f. The clamping element unit 18f comprises a clamping element holding member 36f. The spring unit 26f comprises four spring elements 32f (only one of the four spring elements 32f is illustrated in FIG. 11). The spring elements 32f are configured as flexible springs 28f, in particular as leaf springs 30f.

The spring elements 32f are fastened to a member which is separate from the clamping element holding member 36f. The member is a housing component 62f of a housing 72f of the drive unit. The freewheeling assembly 16f has at least one friction member 94f. The friction member 94f is formed by the housing component 62f. The spring elements 32f are fastened to the member so as to be releasable, in particular in a non-destructive manner. Alternatively, it is also conceivable for the spring elements 32f to be configured so as to be integral to the member, preferably to be at least partially overmoulded by the member. The spring elements 32f are in each case fastened to the member, in particular the housing component 62f, by way of at least one fastening element 64f. The fastening elements 64f are configured as screws, bolts, latching members, clamping members, or the like.

The friction unit 24f comprises at least one friction face 38f which extends in the axial direction. A friction face 38f, which extends in the axial direction, is in each case disposed on the spring elements 32f. The friction faces 38f extending in the axial direction are disposed on a side that faces the clamping element holding member 36f. The spring elements 32f have in each case one spring arm 56f. The respective spring arm 56f of the spring elements 32f is disposed on the side that faces the clamping element holding member 36f, in particular at least when viewed in the axial direction.

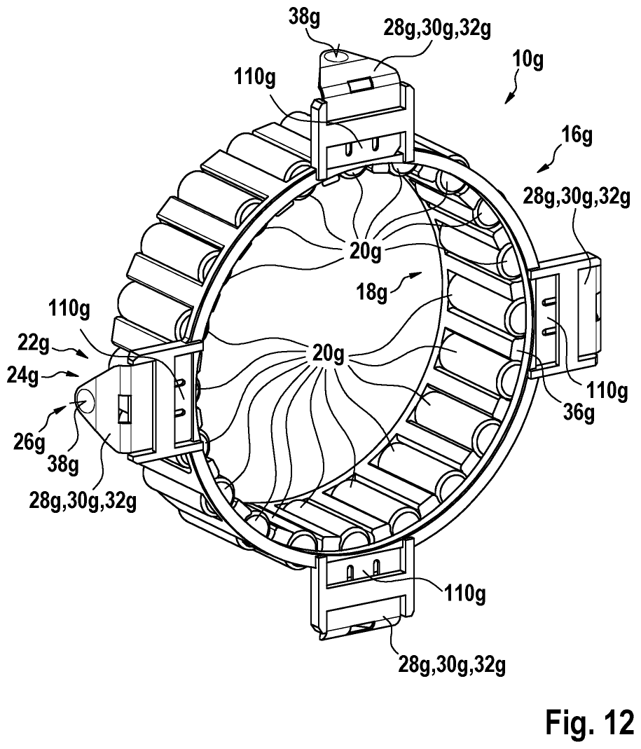

FIG. 12 shows a drive device 10g for a drive unit (not illustrated here) of an electric bicycle (not illustrated here). The drive device 10g has a bidirectional freewheeling assembly 16g. The freewheeling assembly 16g has at least one clamping element unit 18g. The clamping element unit 18g comprises at least one clamping element holding member 36g. The clamping element unit 18g comprises a multiplicity of rolling members 20g.

The clamping element unit 18g comprises at least one mechanical control unit 22g. The control unit 22g has at least one friction unit 24g which is provided to generate an actuating force. The friction unit 24g has at least one spring unit 26g. The spring unit 26g comprises four spring elements 32g. The spring elements 32g are configured as flexible springs 28g, in particular as leaf springs 30g. The spring elements 32g are clamped by way of the clamping element holding member 36g. The four spring elements 32g have in each case in particular one clamping protrusion 102g. The clamping protrusions 102g are configured in such a manner that in an operating position a deflection of the clamping protrusions 102g is able to be generated by an arrangement of the spring elements 32g on the clamping element holding member 36g. The deflection of the clamping protrusions 102g generates a restoring force which acts on the clamping element holding member 36g and thus clamps the spring elements 32f in particular by way of the clamping element holding member 36g. Friction faces 38g of the friction unit 24g point radially outwards. The friction faces 38g are disposed on the spring elements 32g.

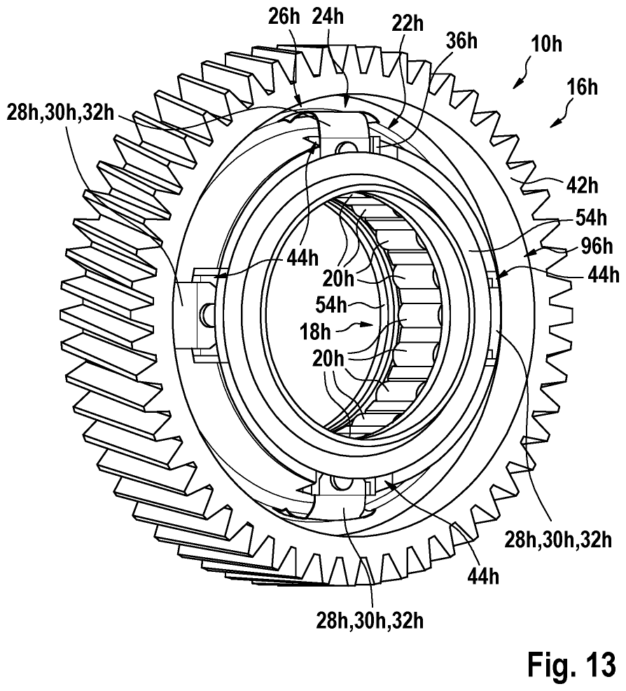

FIG. 13 shows a drive device 10h for a drive unit (not illustrated here) of an electric bicycle (not illustrated here). The drive device 10h comprises at least one force transmission element 42h for transmitting a driving force of the drive unit. The drive device 10h comprises at least one bearing unit 96h. The bearing unit 96h is at least provided to mount the force transmission element 42h and a shaft (not illustrated here) of the drive device 10h so as to be mutually rotatable and/or at a fixed radial spacing relative to one another. The bearing unit 96h comprises at least two bearing elements 54h. The drive device 10h has a bidirectional freewheeling assembly 16h.

The clamping element unit 18h comprises at least one clamping element holding member 36h. The clamping element unit 18h comprises a multiplicity of rolling members 20h. The force transmission element 42h has four lead throughs 44h by way of which the clamping element holding member 36h in the radial direction is at least partially guided towards the outside. The freewheeling assembly 16h has at least one clamping element unit 18h. The clamping element unit 18h comprises at least one mechanical control unit 22h. The control unit 22h has at least one friction unit 24h which is provided to generate an actuating force. The friction unit 24h has at least one spring unit 26h.

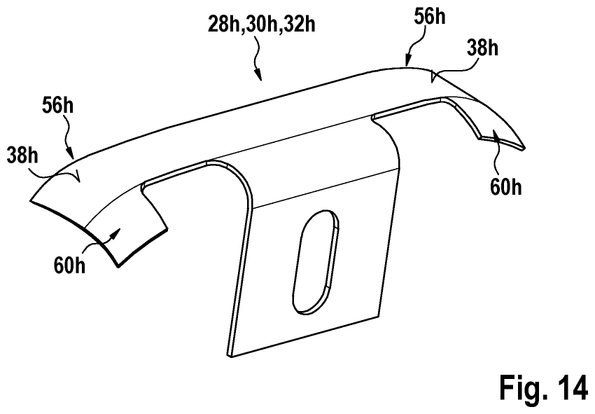

The spring unit 26h has four spring elements 32h. The four spring elements 32h have in each case two assembly ramps 60h (cf. FIG. 14). Alternatively, it is also conceivable for the spring elements 32h to have in each case only one assembly ramp 60h or more than two assembly ramps 60h. The assembly ramps 60h are provided to guide the spring elements 32h when assembling the spring elements 32h on a friction member (not illustrated here). The assembly ramps 60h are provided to contact the friction member during the assembly of the spring elements 32h on the friction member and, in particular, to guide the spring elements 32h in a movement in the direction of an envisaged assembly position. The assembly ramps 60h are disposed on spring arms 56h of the spring elements 32h. The spring elements 32h are configured as flexible springs 28h, in particular as leaf springs 30h.

Friction faces 38h of the friction unit 24h are disposed on the spring elements 32h. The friction faces 38h extend in the axial direction. The friction faces 38h extending in the axial direction, when viewed in the radial direction, are oriented outwards.

1. A drive device for a drive unit of an electric bicycle, comprising:
a bidirectional freewheeling assembly, wherein the freewheeling assembly comprises at least one clamping element unit.

2. The drive device according to claim 1, wherein the clamping element unit is configured to decouple vibrations of a wrapping mechanism.

3. The drive device according to claim 1, wherein the clamping element unit comprises at least one rolling member.

4. The drive device according to claim 1, wherein the clamping element unit comprises a clamping element holding member.

5. The drive device according to claim 1, wherein:
the clamping element unit comprises a mechanical control unit,
the control unit has a friction unit which is configured to generate an actuating force, and
the friction unit has at least one spring unit.

6. (canceled)

7. (canceled)

8. (canceled)

9. (canceled)

10. (canceled)

11. (canceled)

12. The drive device according to claim 5, wherein the spring unit has at least one spring element with at least one assembly ramp.

13. The drive device according to claim 5, wherein the spring unit has at least one spring element which is configured separately from the clamping element holding member.

14. The drive device according to claim 5, wherein the spring unit has at least one spring element which is fastened to a member that is separate from the clamping element holding member.

15. The drive device according to claim 5, wherein the spring unit has at least one spring element which is fastened to the clamping element holding member.

16. The drive device at least according to claim 5, wherein the spring unit has at least one spring element which is configured so as to be integral to the clamping element holding member.

17. The drive device at least according to claim 5, wherein the spring unit has at least one spring element which is overmoulded by the clamping element holding member.

18. The drive device according to claim 5, wherein the friction unit has a friction face extending in the axial direction, and wherein the friction face extending in the axial direction, when viewed in the axial direction, is disposed on a side that faces the clamping element holding member.

19. (canceled)

20. The drive device according to claim 18, wherein the friction face extending in the axial direction, when viewed in the axial direction, is disposed on a side that faces away from the clamping element holding member.

21. The drive device according to claim 18, wherein the friction face extending in the axial direction, when viewed in the radial direction, is aligned towards the inside.

22. The drive device according to claim 5, wherein the friction unit comprises at least two friction elements configured to generate an actuating force, and wherein the friction elements are disposed uniformly in the circumferential direction of the clamping element holding member.

23. The drive device according to claim 4, further comprising a force transmission element configured to transmit a driving force of the drive unit, said force transmission element having at least one lead through by way of which the clamping element holding member in the radial direction is at least partially guided towards the outside.

24. The drive device according to claim 1, further comprising a force transmission element configured to generate a driving force of the drive unit, said force transmission element being configured as a spur gear.

25. The drive device according to claim 3, further comprising a force transmission element configured to transmit a driving force of the drive unit, and wherein a value of a maximum diameter of the at least one rolling member is between 6% and 20% of a value of a maximum internal diameter of the force transmission element.

26. (canceled)

27. (canceled)

28. (canceled)

29. (canceled)

30. (canceled)

31. (canceled)

32. (canceled)

33. (canceled)

34. (canceled)
